(19) United States
(12) Patent Application Publication
(10) Pub. No.: US 2026/0030848 A1
(43) Pub. Date: Jan. 29, 2026

(54) AUGMENTED REALITY SHARED SCREEN SPACE

(71) Applicant: Snap Inc., Santa Monica, CA (US)

(72) Inventors: Ilteris Kaan Canberk, Los Angeles, CA (US); Bernhard Jung, Perchtoldsdorf (AT); Shin Hwun Kang, Los Angeles, CA (US); Daria Skrypnyk, Beverly Hills, CA (US)

(21) Appl. No.: 19/346,863

(22) Filed: Oct. 1, 2025

Related U.S. Application Data
(63) Continuation of application No. 18/078,522, filed on Dec. 9, 2022, now Pat. No. 12,475,658.

(51) Int. Cl. G06T 19/00; H04L 67/131

(52) U.S. Cl. CPC G06T 19/006; H04L 67/131

(57) ABSTRACT

Systems, methods, and computer readable media for an augmented reality (AR) shared screen space. Examples relate to a host augmented realty (AR) device sharing a screen and a relative location of the AR device to the screen with guest AR devices where the guest AR devices share a relative location of the guest AR devices to a copy of the screen displayed on the display of the guest AR devices and where the users of the AR devices may see each other's location with the use of avatars around the shared screen and add augmentations to the shared screen. The yaw, roll, and pitch of the head of the avatars tracks the movement of the head of the user of the AR wearable device.

### TECHNICAL FIELD

This application is a continuation of U.S. patent application Ser. No. 18/078,522, filed on Dec. 9, 2022, which is hereby incorporated by reference in its entirety.

### TECHNICAL FIELD

Examples of the present disclosure relate generally to enabling users to interact within an augmented reality (AR) shared screen space. More particularly, but not by way of limitation, examples of the present disclosure relate to a host augmented realty (AR) device sharing a screen and a relative location of the host AR device to the screen with guest AR devices where the guest AR devices share a relative location of the guest AR devices to a copy of the screen displayed on the display of the guest AR devices, and where the users of the AR devices may see each other's locations with the use of avatars around the shared screen space and add augmentations to the shared screen.

### BACKGROUND

Users increasingly want virtual reality (VR), mixed reality (MR), and augmented reality (AR) wearable devices to operate in a more user-friendly manner with more functions. However, often, the wearable devices have very little room for interface controls on the wearable devices and often the AR wearable devices have limited power to provide additional functions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a diagrammatic representation of a data structure as maintained in a database, in accordance with some examples.

FIG. 4 is a diagrammatic representation of a message, in accordance with some examples.

FIG. 5 is a flowchart for an access-limiting process, in accordance with some examples.

FIG. 6 illustrates a system for an augmented reality (AR) shared screen space, in accordance with some examples.

FIG. 7 illustrates an AR shared screen space, in accordance with some examples.

FIGS. 8A and 8B illustrate positions of the avatars, in accordance with some examples.

FIG. 9 illustrates yaw, roll, and pitch, in accordance with some examples.

FIG. 10 illustrates communications for AR shared screen space, in accordance with some examples.

FIG. 11 is a perspective view of a wearable electronic device in the form of glasses, in accordance with some examples.

FIG. 12 illustrates a method for an augmented reality shared screen space, in accordance with some examples.

FIG. 13 is a diagrammatic representation of a machine in the form of a computer system within which a set of instructions may be executed for causing the machine to perform any one or more of the methodologies discussed herein, in accordance with some examples.

FIG. 14 is a block diagram showing a software architecture within which examples may be implemented.

FIG. 15 is a diagrammatic representation of a processing environment, in accordance with some examples.

### DETAILED DESCRIPTION

The description that follows includes systems, methods, techniques, instruction sequences, and computing machine program products that embody illustrative examples of the disclosure. In the following description, for the purposes of explanation, numerous specific details are set forth in order to provide an understanding of various examples of the inventive subject matter. It will be evident, however, to those skilled in the art, that examples of the inventive subject matter may be practiced without these specific details. In general, well-known instruction instances, protocols, structures, and techniques are not necessarily shown in detail.

The AR wearable device 602 is used as an illustrative device; however, one skilled in the art will recognize that the methods, systems, and computer readable medium disclosed herein are applicable to other wearable devices or non-wearable devices including VR devices and MR devices.

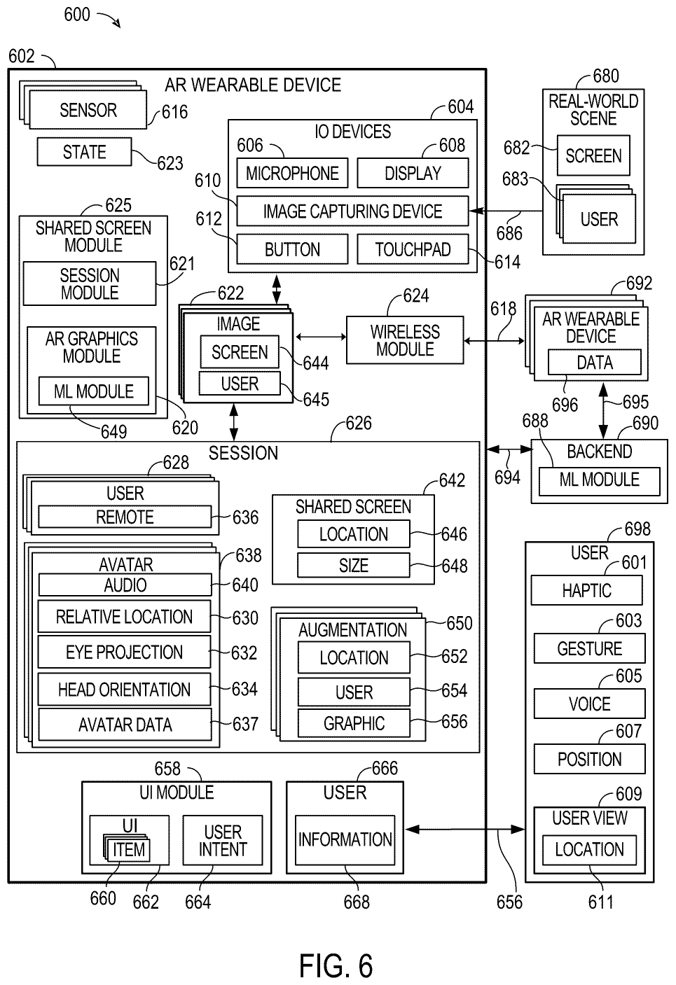

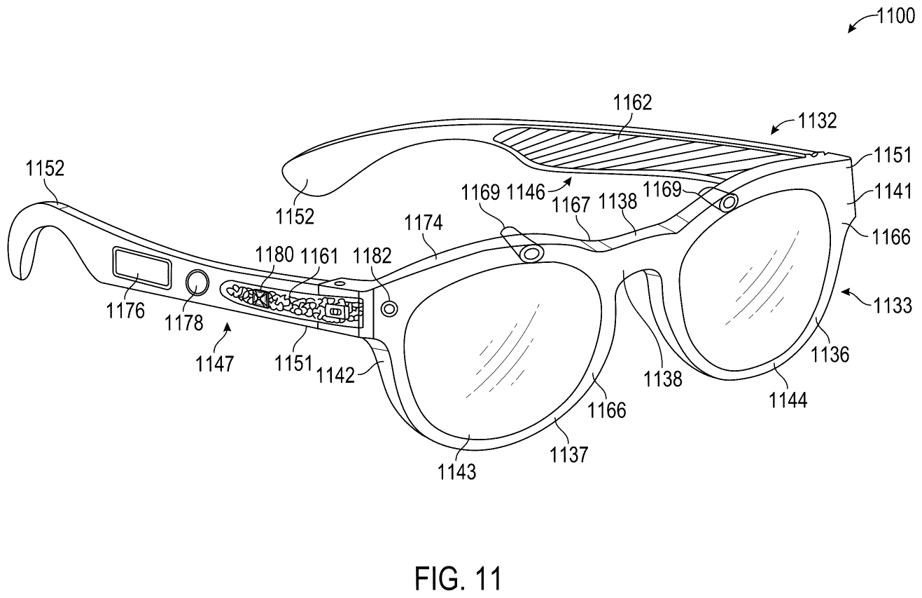

AR wearable devices 602 such as AR glasses 1100 (See FIGS. 6 and 11) have limited physical user interface items. For example, AR glasses 1100 have one or two buttons 1178 and a touchpad 1176 that the user 698 interacts with on a frame 1132 of the AR glasses 1100. Moreover, the AR glasses 1100 have limited battery power, memory, and processing capability.

Often users 628 need to collaborate on a project. But sharing a screen on a desktop computer or other device often fails to provide the user 628 with a sense of working together on a project and feedback that can be provided to one another is often limited to what can be provided by video conferencing applications.

One challenge is how to provide a better user experience for a group of users 628 working on a project. The challenge is addressed, referring to FIG. 6, by the users 628 wearing AR wearable devices 602. A “Host” AR wearable device 602 provides a shared screen 642, which becomes the focal point of the project. The “Host” AR wearable device 602 indicates a size 648 and location 646 of the shared screen 642 and any permanent content on shared screen 642. Additionally, the “Host” AR wearable device 602 provides information about an avatar 638 for the user 698 of the “Host” AR wearable device 602. The information includes a relative location 630 of the user 698 to the shared screen 642 and a head orientation 634 of the user 698 of the “Host” AR wearable device 602.

A “Guest” AR wearable device 692 after receiving this information can display on a display 608 of the “Guest” AR wearable device 692 the shared screen 642, a relative location 630 to the shared screen 642 of the “Host” avatar 638, and a head orientation 634 of the “Host” avatar 638. Similarly, the “Guest” AR wearable device 692 shares avatar 638 information with the “Host” AR wearable device 602 so that the “Host” AR wearable device 602 can display on a display 608 of the “Host” AR wearable device 602 an avatar 638 of the user 628 of the “Guest” AR wearable device 602.

Additionally, augmentations 650 such as emoji, images, drawings, and such can be shared between the “Host” AR wearable device 602 and the “Guest” AR wearable device 692. In some examples, the augmentation 650 may be a video feed from a “Guest” AR wearable device 692. For example, a “Guest” AR wearable device 692 may share a slide presentation as an augmentation 650 or share the contents of a screen of a computing device which may be playing a video. The augmentations 650 are displayed on the shared screen 642. There can be more than one “Guest” and a “Guest” may be local so that if the user 698 of the “Host” AR wearable device 602 and a user 628 of the “Guest” AR wearable device 692 are in the same room, then avatars 638 are not used for the users 628 in the same physical location, in accordance with some embodiments. In some embodiments, avatars 638 or another representation are used for the users 628 in the same physical location. An eye projection 632 may be displayed on the shared screen 642 indicating where the eyes of the user 698 of the “Host” or “Guest” AR wearable device 602 appear to be looking at the shared screen 642.

The “Guest” users 628 and the “Host” user 698 can then share augmentations 650, avatars 638, audio 640, and a shared screen 642. The “Guest” users 628 and the “Host” user 698 can see where each other are standing relative to the shared screen 642 and can see movements of the heads of the “Guest” users 628 and the “Host” user 698 via the movements of their respective avatars 638. The increased interaction provides a more suitable environment for the “Guest” users 628 and the “Host” user 698 to work on a project within the shared screen 642 space.

### Networked Computing Environment

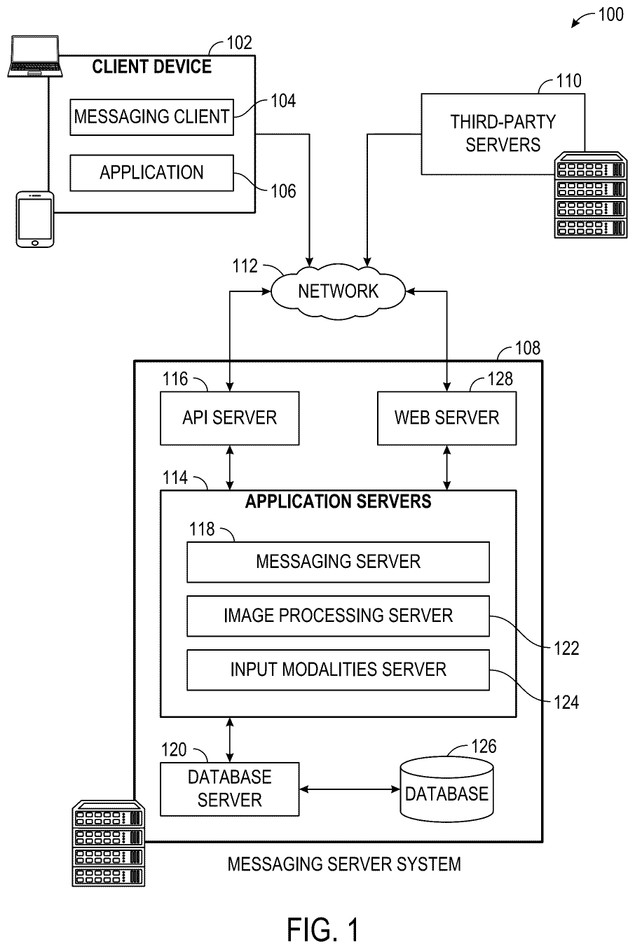

FIG. 1 is a block diagram showing an example messaging system 100 for exchanging data (e.g., messages and associated content) over a network. The messaging system 100 includes multiple instances of a client device 102, each of which hosts a number of applications, including a messaging client 104 and other applications 106. Each messaging client 104 is communicatively coupled to other instances of the messaging client 104 (e.g., hosted on respective other client devices 102), a messaging server system 108 and third-party servers 110 via a network 112 (e.g., the Internet). A messaging client 104 can also communicate with locally-hosted applications 106 using Applications Program Interfaces (APIs).

A messaging client 104 is able to communicate and exchange data with other messaging clients 104 and with the messaging server system 108 via the network 112. The data exchanged between messaging clients 104, and between a messaging client 104 and the messaging server system 108, includes functions (e.g., commands to invoke functions) as well as payload data (e.g., text, audio, video or other multimedia data).

The messaging server system 108 provides server-side functionality via the network 112 to a particular messaging client 104. While certain functions of the messaging system 100 are described herein as being performed by either a messaging client 104 or by the messaging server system 108, the location of certain functionality either within the messaging client 104 or the messaging server system 108 may be a design choice. For example, it may be technically preferable to initially deploy certain technology and functionality within the messaging server system 108 but to later migrate this technology and functionality to the messaging client 104 where a client device 102 has sufficient processing capacity.

The messaging server system 108 supports various services and operations that are provided to the messaging client 104. Such operations include transmitting data to, receiving data from, and processing data generated by the messaging client 104. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 104.

Turning now specifically to the messaging server system 108, an Application Program Interface (API) server 116 is coupled to, and provides a programmatic interface to, application servers 114. The application servers 114 are communicatively coupled to a database server 120, which facilitates access to a database 126 that stores data associated with messages processed by the application servers 114. Similarly, a web server 128 is coupled to the application servers 114, and provides web-based interfaces to the application servers 114. To this end, the web server 128 processes incoming network requests over the Hypertext Transfer Protocol (HTTP) and several other related protocols.

The Application Program Interface (API) server 116 receives and transmits message data (e.g., commands and message payloads) between the client device 102 and the application servers 114. Specifically, the Application Program Interface (API) server 116 provides a set of interfaces (e.g., routines and protocols) that can be called or queried by the messaging client 104 in order to invoke functionality of the application servers 114. The Application Program Interface (API) server 116 exposes various functions supported by the application servers 114, including account registration, login functionality, the sending of messages, via the application servers 114, from a particular messaging client 104 to another messaging client 104, the sending of media files (e.g., images or video) from a messaging client 104 to a messaging server 118, and for possible access by another messaging client 104, the settings of a collection of media data (e.g., story), the retrieval of a list of friends of a user of a client device 102, the retrieval of such collections, the retrieval of messages and content, the addition and deletion of entities (e.g., friends) to an entity graph (e.g., a social graph), the location of friends within a social graph, and opening an application event (e.g., relating to the messaging client 104).

The application servers 114 host a number of server applications and subsystems, including for example a messaging server 118, an image processing server 122, and an input modalities server 124. The messaging server 118 implements a number of message processing technologies and functions, particularly related to the aggregation and other processing of content (e.g., textual and multimedia content) included in messages received from multiple instances of the messaging client 104. As will be described in further detail, the text and media content from multiple sources may be aggregated into collections of content (e.g., called stories or galleries). These collections are then made available to the messaging client 104. Other processor and memory intensive processing of data may also be performed server-side by the messaging server 118, in view of the hardware requirements for such processing.

The application servers 114 also include an image processing server 122 that is dedicated to performing various image processing operations, typically with respect to images or video within the payload of a message sent from or received at the messaging server 118.

The input modalities server 124 supports input modalities for AR wearable devices. The input modalities server 124 receives requests from an AR wearable device and responds to the requests. The requests include sensor data such as an image being sent to the input modalities server 124 for processing. The input modalities server 124 processes the sensor data and identifies objects within the sensor data and returns names of the objects and positions of the objects within the sensor data to the AR wearable device. Another request from the AR wearable device is for AR applications associated with tags such as “QR code” that may be run on the AR wearable device. The input modalities server 124 may load the AR wearable device with AR applications that are likely to be used by a user of the AR wearable device or respond with AR applications based on criteria given to the input modalities server 124 from the AR wearable device. The criteria may be as a limit on the number of AR applications, preferences of the user such as AR applications with links back to the messaging system 100, and so forth.

Returning to the messaging client 104, features and functions of an external resource (e.g., an application 106 or applet) are made available to a user via an interface of the messaging client 104. In this context, “external” refers to the fact that the application 106 or applet is external to the messaging client 104. The external resource is often provided by a third party but may also be provided by the creator or provider of the messaging client 104. The messaging client 104 receives a user selection of an option to launch or access features of such an external resource. The external resource may be the application 106 installed on the client device 102 (e.g., a “native app”), or a small-scale version of the application (e.g., an “applet”) that is hosted on the client device 102 or remote of the client device 102 (e.g., on third-party servers 110). The small-scale version of the application includes a subset of features and functions of the application (e.g., the full-scale, native version of the application) and is implemented using a markup-language document. In one example, the small-scale version of the application (e.g., an “applet”) is a web-based, markup-language version of the application and is embedded in the messaging client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the messaging client 104 determines whether the selected external resource is a web-based external resource or a locally-installed application 106. In some cases, applications 106 that are locally installed on the client device 102 can be launched independently of and separately from the messaging client 104, such as by selecting an icon, corresponding to the application 106, on a home screen of the client device 102. Small-scale versions of such applications can be launched or accessed via the messaging client 104 and, in some examples, no or limited portions of the small-scale application can be accessed outside of the messaging client 104. The small-scale application can be launched by the messaging client 104 receiving, from a third-party server 110 for example, a markup-language document associated with the small-scale application and processing such a document.

In response to determining that the external resource is a locally-installed application 106, the messaging client 104 instructs the client device 102 to launch the external resource by executing locally-stored code corresponding to the external resource. In response to determining that the external resource is a web-based resource, the messaging client 104 communicates with the third-party servers 110 (for example) to obtain a markup-language document corresponding to the selected external resource. The messaging client 104 then processes the obtained markup-language document to present the web-based external resource within a user interface of the messaging client 104.

The messaging client 104 can notify a user of the client device 102, or other users related to such a user (e.g., “friends”), of activity taking place in one or more external resources. For example, the messaging client 104 can provide participants in a conversation (e.g., a chat session) in the messaging client 104 with notifications relating to the current or recent use of an external resource by one or more members of a group of users. One or more users can be invited to join in an active external resource or to launch a recently-used but currently inactive (in the group of friends) external resource. The external resource can provide participants in a conversation, each using respective messaging clients 104, with the ability to share an item, status, state, or location in an external resource with one or more members of a group of users into a chat session. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the messaging client 104. The external resource can selectively include different media items in the responses, based on a current context of the external resource.

The messaging client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

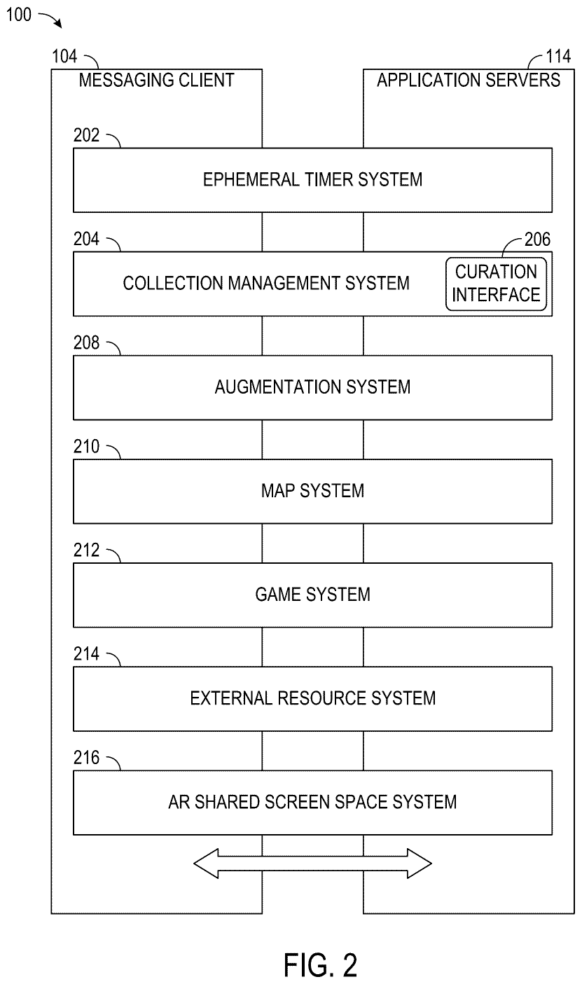

FIG. 2 is a block diagram illustrating further details regarding the messaging system 100, according to some examples. Specifically, the messaging system 100 is shown to comprise the messaging client 104 and the application servers 114. The messaging system 100 embodies a number of subsystems, which are supported on the client-side by the messaging client 104 and on the server-side by the application servers 114. These subsystems include, for example, an ephemeral timer system 202, a collection management system 204, an augmentation system 208, a map system 210, a game system 212, an external resource system 214, and an AR shared screen space system 216.

The ephemeral timer system 202 is responsible for enforcing the temporary or time-limited access to content by the messaging client 104 and the messaging server 118. The ephemeral timer system 202 incorporates a number of timers that, based on duration and display parameters associated with a message, or collection of messages (e.g., a story), selectively enable access (e.g., for presentation and display) to messages and associated content via the messaging client 104. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 104.

The collection management system 204 furthermore includes a curation interface 206 that allows a collection manager to manage and curate a particular collection of content. For example, the curation interface 206 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 208 provides various functions that enable a user to augment (e.g., annotate or otherwise modify or edit) media content associated with a message. For example, the augmentation system 208 provides functions related to the generation and publishing of media overlays for messages processed by the messaging system 100. The augmentation system 208 operatively supplies a media overlay or augmentation (e.g., an image filter) to the messaging client 104 based on a geolocation of the client device 102. In another example, the augmentation system 208 operatively supplies a media overlay to the messaging client 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo, a digital object,) at the client device 102. For example, the media overlay may include text or image that can be overlaid on top of a photograph taken by the client device 102. In another example, the media overlay includes an identification of a location overlay (e.g., Venice beach), a name of a live event, or a name of a merchant overlay (e.g., Beach Coffee House). In another example, the augmentation system 208 uses the geolocation of the client device 102 to identify a media overlay that includes the name of a merchant at the geolocation of the client device 102. The media overlay may include other indicia associated with the merchant. The media overlays may be stored in the database 126 and accessed through the database server 120.

In some examples, the augmentation system 208 provides a user-based publication platform that enables users to select a geolocation on a map and upload content associated with the selected geolocation. The user may also specify circumstances under which a particular media overlay should be offered to other users. The augmentation system 208 generates a media overlay that includes the uploaded content and associates the uploaded content with the selected geolocation.

In other examples, the augmentation system 208 provides a merchant-based publication platform that enables merchants to select a particular media overlay associated with a geolocation via a bidding process. For example, the augmentation system 208 associates the media overlay of the highest bidding merchant with a corresponding geolocation for a predefined amount of time.

The map system 210 provides various geographic location functions and supports the presentation of map-based media content and messages by the messaging client 104. For example, the map system 210 enables the display of user icons or avatars (e.g., stored in profile data 316) on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 104. A user can furthermore share his or her location and status information (e.g., using an appropriate status avatar) with other users of the messaging system 100 via the messaging client 104, with this location and status information being similarly displayed within the context of a map interface of the messaging client 104 to selected users.

The game system 212 provides various gaming functions within the context of the messaging client 104. The messaging client 104 provides a game interface providing a list of available games that can be launched by a user within the context of the messaging client 104 and played with other users of the messaging system 100. The messaging system 100 further enables a particular user to invite other users to participate in the play of a specific game, by issuing invitations to such other users from the messaging client 104. The messaging client 104 also supports both voice and text messaging (e.g., chats) within the context of gameplay, provides a leaderboard for the games, and also supports the provision of in-game rewards (e.g., coins and items).

The external resource system 214 provides an interface for the messaging client 104 to communicate with remote servers (e.g., third-party servers 110) to launch or access external resources, e.g., applications or applets. Each third-party server 110 hosts, for example, a markup language (e.g., HTML5) based application or small-scale version of an application (e.g., game, utility, payment, or ride-sharing application). The messaging client 104 may launch a web-based resource (e.g., application) by accessing the HTML5 file from the third-party servers 110 associated with the web-based resource. In certain examples, applications hosted by third-party servers 110 are programmed in JavaScript leveraging a Software Development Kit (SDK) provided by the messaging server 118. The SDK includes Application Programming Interfaces (APIs) with functions that can be called or invoked by the web-based application. In certain examples, the messaging server 118 includes a JavaScript library that provides a given external resource access to certain user data of the messaging client 104. HTML5 is used as an example technology for programming games, but applications and resources programmed based on other technologies can be used.

In order to integrate the functions of the SDK into the web-based resource, the SDK is downloaded by a third-party server 110 from the messaging server 118 or is otherwise received by the third-party server 110. Once downloaded or received, the SDK is included as part of the application code of a web-based external resource. The code of the web-based resource can then call or invoke certain functions of the SDK to integrate features of the messaging client 104 into the web-based resource.

The SDK stored on the messaging server 118 effectively provides the bridge between an external resource (e.g., applications 106 or applets and the messaging client 104. This provides the user with a seamless experience of communicating with other users on the messaging client 104, while also preserving the look and feel of the messaging client 104. To bridge communications between an external resource and a messaging client 104, in certain examples, the SDK facilitates communication between third-party servers 110 and the messaging client 104. In certain examples, a WebViewJavaScriptBridge running on a client device 102 establishes two one-way communication channels between an external resource and the messaging client 104. Messages are sent between the external resource and the messaging client 104 via these communication channels asynchronously. Each SDK function invocation is sent as a message and callback. Each SDK function is implemented by constructing a unique callback identifier and sending a message with that callback identifier.

By using the SDK, not all information from the messaging client 104 is shared with third-party servers 110. The SDK limits which information is shared based on the needs of the external resource. In certain examples, each third-party server 110 provides an HTML5 file corresponding to the web-based external resource to the messaging server 118. The messaging server 118 can add a visual representation (such as a box art or other graphic) of the web-based external resource in the messaging client 104. Once the user selects the visual representation or instructs the messaging client 104 through a GUI of the messaging client 104 to access features of the web-based external resource, the messaging client 104 obtains the HTML5 file and instantiates the resources necessary to access the features of the web-based external resource.

The messaging client 104 presents a graphical user interface (e.g., a landing page or title screen) for an external resource. During, before, or after presenting the landing section of reading materials such as a page or title screen, the messaging client 104 determines whether the launched external resource has been previously authorized to access user data of the messaging client 104. In response to determining that the launched external resource has been previously authorized to access user data of the messaging client 104, the messaging client 104 presents another graphical user interface of the external resource that includes functions and features of the external resource. In response to determining that the launched external resource has not been previously authorized to access user data of the messaging client 104, after a threshold period of time (e.g., 3 seconds) of displaying the landing page or title screen of the external resource, the messaging client 104 slides up (e.g., animates a menu as surfacing from a bottom of the screen to a middle of or other portion of the screen) a menu for authorizing the external resource to access the user data. The menu identifies the type of user data that the external resource will be authorized to use. In response to receiving a user selection of an accept option, the messaging client 104 adds the external resource to a list of authorized external resources and allows the external resource to access user data from the messaging client 104. In some examples, the external resource is authorized by the messaging client 104 to access the user data in accordance with an OAuth 2 framework.

The messaging client 104 controls the type of user data that is shared with external resources based on the type of external resource being authorized. For example, external resources that include full-scale applications (e.g., an application 106) are provided with access to a first type of user data (e.g., only two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

The AR shared screen space system 216 supports, referring to FIG. 6, system 600 for an AR shared screen space. The AR shared screen space system 216 receives requests from an AR wearable device 602, AR wearable device 692, or user device 102 and responds to the requests. The requests include a request to download avatar data 637 of a user 628 and to send messages among AR wearable devices 602, 692 that are sharing a shared screen 642 space. AR wearable devices 602 may request other services from the AR shared screen space system 216 including processing images 622 to identify the location 646 and size 648 of the shared screen 642 within the image 622.

### Data Architecture

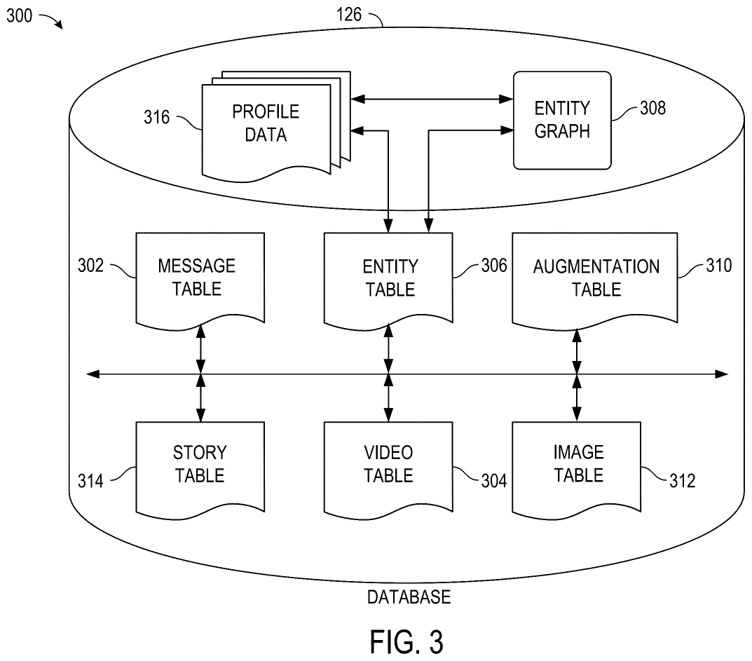

FIG. 3 is a schematic diagram illustrating data structures 300, which may be stored in the database 126 of the messaging server system 108, according to certain examples. While the content of the database 126 is shown to comprise a number of tables, it will be appreciated that the data could be stored in other types of data structures (e.g., as an object-oriented database).

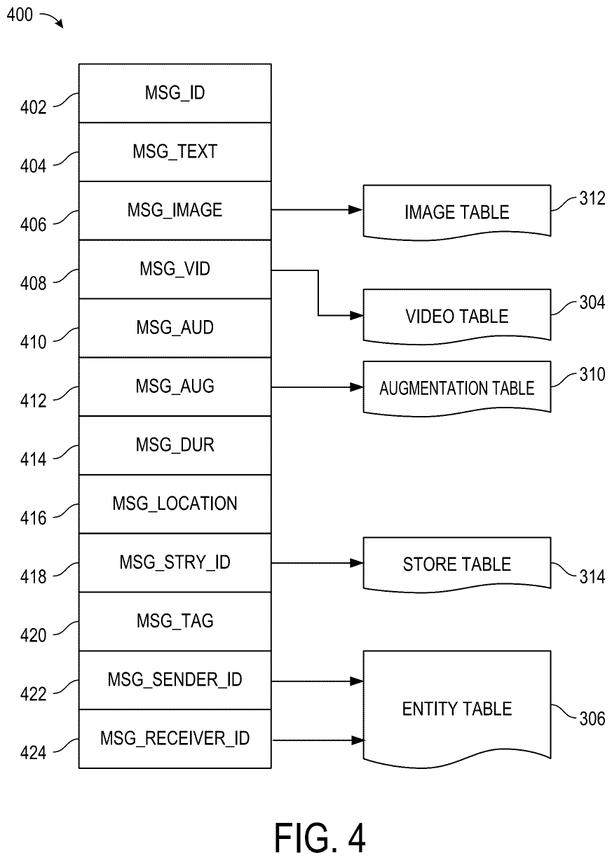

The database 126 includes message data stored within a message table 302. This message data includes, for any particular one message, at least message sender data, message recipient (or receiver) data, and a payload. Further details regarding information that may be included in a message, and included within the message data stored in the message table 302 is described below with reference to FIG. 4.

An entity table 306 stores entity data, and is linked (e.g., referentially) to an entity graph 308 and profile data 316. Entities for which records are maintained within the entity table 306 may include individuals, corporate entities, organizations, objects, places, events, and so forth. Regardless of entity type, any entity regarding which the messaging server system 108 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization) interested-based or activity-based, merely for example.

The profile data 316 stores multiple types of profile data about a particular entity. The profile data 316 may be selectively used and presented to other users of the messaging system 100, based on privacy settings specified by a particular entity. Where the entity is an individual, the profile data 316 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the messaging system 100, and on map interfaces displayed by messaging clients 104 to other users. The collection of avatar representations may include “status avatars,” which present a graphical representation of a status or activity that the user may select to communicate at a particular time.

Where the entity is a group, the profile data 316 for the group may similarly include one or more avatar representations associated with the group, in addition to the group name, members, and various settings (e.g., notifications) for the relevant group.

The database 126 also stores augmentation data, such as overlays or filters, in an augmentation table 310. The augmentation data is associated with and applied to videos (for which data is stored in a video table 304) and images (for which data is stored in an image table 312).

Filters, in one example, are overlays that are displayed as overlaid on an image or video during presentation to a recipient user. Filters may be of various types, including user-selected filters from a set of filters presented to a sending user by the messaging client 104 when the sending user is composing a message. Other types of filters include geolocation filters (also known as geo-filters), which may be presented to a sending user based on geographic location. For example, geolocation filters specific to a neighborhood or special location may be presented within a user interface by the messaging client 104, based on geolocation information determined by a Global Positioning System (GPS) unit of the client device 102.

Another type of filter is a data filter, which may be selectively presented to a sending user by the messaging client 104, based on other inputs or information gathered by the client device 102 during the message creation process. Examples of data filters include current temperature at a specific location, a current speed at which a sending user is traveling, battery life for a client device 102, or the current time.

Other augmentation data that may be stored within the image table 312 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of a client device 102 and then displayed on a screen of the client device 102 with the modifications. This also includes modifications to stored content, such as video clips in a gallery that may be modified. For example, in a client device 102 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various examples, different methods for achieving such transformations may be used. Some examples may involve generating a three-dimensional mesh model of the object or objects, and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device, or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh is used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various examples, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some examples, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In some examples, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In some systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

In some examples, a computer animation model to transform image data can be used by a system where a user may capture an image or video stream of the user (e.g., a selfie) using a client device 102 having a neural network operating as part of a messaging client 104 operating on the client device 102. The transformation system operating within the messaging client 104 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client device 102 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various examples, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some examples, individual faces, among a group of multiple faces, may be individually modified, or such modifications may be individually toggled by tapping or selecting the individual face or a series of individual faces displayed within the graphical user interface.

A story table 314 stores data regarding collections of messages and associated image, video, or audio data, which are compiled into a collection (e.g., a story or a gallery). The creation of a particular collection may be initiated by a particular user (e.g., each user for which a record is maintained in the entity table 306). A user may create a “personal story” in the form of a collection of content that has been created and sent/broadcast by that user. To this end, the user interface of the messaging client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the messaging client 104, to contribute content to a particular live story. The live story may be identified to the user by the messaging client 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some examples, a contribution to a location story may require a second degree of authentication to verify that the end-user belongs to a specific organization or other entity (e.g., is a student on the university campus).

As mentioned above, the video table 304 stores video data that, in one example, is associated with messages for which records are maintained within the message table 302. Similarly, the image table 312 stores image data associated with messages for which message data is stored in the entity table 306. The entity table 306 may associate various augmentations from the augmentation table 310 with various images and videos stored in the image table 312 and the video table 304.

### Data Communications Architecture

FIG. 4 is a schematic diagram illustrating a structure of a message 400, according to some examples, generated by a messaging client 104 for communication to a further messaging client 104 or the messaging server 118. The content of a particular message 400 is used to populate the message table 302 stored within the database 126, accessible by the messaging server 118. Similarly, the content of a message 400 is stored in memory as “in-transit” or “in-flight” data of the client device 102 or the application servers 114. A message 400 is shown to include the following example components:
message identifier 402: a unique identifier that identifies the message 400.
message text payload 404: text, to be generated by a user via a user interface of the client device 102, and that is included in the message 400.
message image payload 406: image data, captured by a camera component of a client device 102 or retrieved from a memory component of a client device 102, and that is included in the message 400. Image data for a sent or received message 400 may be stored in the image table 312.
message video payload 408: video data, captured by a camera component or retrieved from a memory component of the client device 102, and that is included in the message 400. Video data for a sent or received message 400 may be stored in the video table 304.
message audio payload 410: audio data, captured by a microphone or retrieved from a memory component of the client device 102, and that is included in the message 400.
message augmentation data 412: augmentation data (e.g., filters, stickers, or other annotations or enhancements) that represents augmentations to be applied to message image payload 406, message video payload 408, or message audio payload 410 of the message 400. Augmentation data for a sent or received message 400 may be stored in the augmentation table 310.
message duration parameter 414: parameter value indicating, in seconds, the amount of time for which content of the message (e.g., the message image payload 406, message video payload 408, message audio payload 410) is to be presented or made accessible to a user via the messaging client 104.
message geolocation parameter 416: geolocation data (e.g., latitudinal and longitudinal coordinates) associated with the content payload of the message. Multiple message geolocation parameter 416 values may be included in the payload, each of these parameter values being associated with respect to content items included in the content (e.g., a specific image into within the message image payload 406, or a specific video in the message video payload 408).
message story identifier 418: identifier values identifying one or more content collections (e.g., “stories” identified in the story table 314) with which a particular content item in the message image payload 406 of the message 400 is associated. For example, multiple images within the message image payload 406 may each be associated with multiple content collections using identifier values.
message tag 420: each message 400 may be tagged with multiple tags, each of which is indicative of the subject matter of content included in the message payload. For example, where a particular image included in the message image payload 406 depicts an animal (e.g., a lion), a tag value may be included within the message tag 420 that is indicative of the relevant animal. Tag values may be generated manually, based on user input, or may be automatically generated using, for example, image recognition.
message sender identifier 422: an identifier (e.g., a messaging system identifier, email address, or device identifier) indicative of a user of the Client device 102 on which the message 400 was generated and from which the message 400 was sent.
message receiver identifier 424: an identifier (e.g., a messaging system identifier, email address, or device identifier) indicative of a user of the client device 102 to which the message 400 is addressed.

The contents (e.g., values) of the various components of message 400 may be pointers to locations in tables within which content data values are stored. For example, an image value in the message image payload 406 may be a pointer to (or address of) a location within an image table 312. Similarly, values within the message video payload 408 may point to data stored within a video table 304, values stored within the message augmentations 412 may point to data stored in an augmentation table 310, values stored within the message story identifier 418 may point to data stored in a story table 314, and values stored within the message sender identifier 422 and the message receiver identifier 424 may point to user records stored within an entity table 306.

### Time-Based Access Limitation Architecture

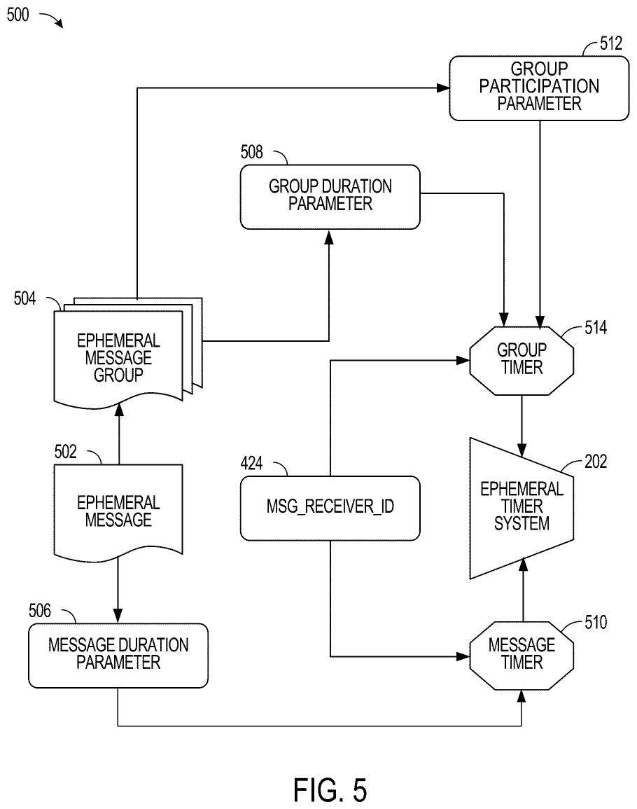

FIG. 5 is a schematic diagram illustrating an access-limiting process 500, in terms of which access to content (e.g., an ephemeral message 502, and associated multimedia payload of data) or a content collection (e.g., an ephemeral message group 504) may be time-limited (e.g., made ephemeral).

An ephemeral message 502 is shown to be associated with a message duration parameter 506, the value of which determines an amount of time that the ephemeral message 502 will be displayed to a receiving user of the ephemeral message 502 by the messaging client 104. In one example, an ephemeral message 502 is viewable by a receiving user for up to a maximum of 10 seconds, depending on the amount of time that the sending user specifies using the message duration parameter 506.

The message duration parameter 506 and the message receiver identifier 424 are shown to be inputs to a message timer 510, which is responsible for determining the amount of time that the ephemeral message 502 is shown to a particular receiving user identified by the message receiver identifier 424. In particular, the ephemeral message 502 will only be shown to the relevant receiving user for a time period determined by the value of the message duration parameter 506. The message timer 510 is shown to provide output to a more generalized ephemeral timer system 202, which is responsible for the overall timing of display of content (e.g., an ephemeral message 502) to a receiving user.

The ephemeral message 502 is shown in FIG. 5 to be included within an ephemeral message group 504 (e.g., a collection of messages in a personal story, or an event story). The ephemeral message group 504 has an associated group duration parameter 508, a value of which determines a time duration for which the ephemeral message group 504 is presented and accessible to users of the messaging system 100. The group duration parameter 508, for example, may be the duration of a music concert, where the ephemeral message group 504 is a collection of content pertaining to that concert. Alternatively, a user (either the owning user or a curator user) may specify the value for the group duration parameter 508 when performing the setup and creation of the ephemeral message group 504.

Additionally, each ephemeral message 502 within the ephemeral message group 504 has an associated group participation parameter 512, a value of which determines the duration of time for which the ephemeral message 502 will be accessible within the context of the ephemeral message group 504. Accordingly, a particular ephemeral message group 504 may “expire” and become inaccessible within the context of the ephemeral message group 504, prior to the ephemeral message group 504 itself expiring in terms of the group duration parameter 508. The group duration parameter 508, group participation parameter 512, and message receiver identifier 424 each provide input to a group timer 514, which operationally determines, firstly, whether a particular ephemeral message 502 of the ephemeral message group 504 will be displayed to a particular receiving user and, if so, for how long. Note that the ephemeral message group 504 is also aware of the identity of the particular receiving user as a result of the message receiver identifier 424.

Accordingly, the group timer 514 operationally controls the overall lifespan of an associated ephemeral message group 504, as well as an individual ephemeral message 502 included in the ephemeral message group 504. In one example, each and every ephemeral message 502 within the ephemeral message group 504 remains viewable and accessible for a time period specified by the group duration parameter 508. In a further example, a certain ephemeral message 502 may expire, within the context of ephemeral message group 504, based on a group participation parameter 512. Note that a message duration parameter 506 may still determine the duration of time for which a particular ephemeral message 502 is displayed to a receiving user, even within the context of the ephemeral message group 504. Accordingly, the message duration parameter 506 determines the duration of time that a particular ephemeral message 502 is displayed to a receiving user, regardless of whether the receiving user is viewing that ephemeral message 502 inside or outside the context of an ephemeral message group 504.

The ephemeral timer system 202 may furthermore operationally remove a particular ephemeral message 502 from the ephemeral message group 504 based on a determination that it has exceeded an associated group participation parameter 512. For example, when a sending user has established a group participation parameter 512 of 24 hours from posting, the ephemeral timer system 202 will remove the relevant ephemeral message 502 from the ephemeral message group 504 after the specified 24 hours. The ephemeral timer system 202 also operates to remove an ephemeral message group 504 when either the group participation parameter 512 for each and every ephemeral message 502 within the ephemeral message group 504 has expired, or when the ephemeral message group 504 itself has expired in terms of the group duration parameter 508.

In certain use cases, a creator of a particular ephemeral message group 504 may specify an indefinite group duration parameter 508. In this case, the expiration of the group participation parameter 512 for the last remaining ephemeral message 502 within the ephemeral message group 504 will determine when the ephemeral message group 504 itself expires. In this case, a new ephemeral message 502, added to the ephemeral message group 504, with a new group participation parameter 512, effectively extends the life of an ephemeral message group 504 to equal the value of the group participation parameter 512.

Responsive to the ephemeral timer system 202 determining that an ephemeral message group 504 has expired (e.g., is no longer accessible), the ephemeral timer system 202 communicates with the messaging system 100 (and, for example, specifically the messaging client 104) to cause an indicium (e.g., an icon) associated with the relevant ephemeral message group 504 to no longer be displayed within a user interface of the messaging client 104. Similarly, when the ephemeral timer system 202 determines that the message duration parameter 506 for a particular ephemeral message 502 has expired, the ephemeral timer system 202 causes the messaging client 104 to no longer display an indicium (e.g., an icon or textual identification) associated with the ephemeral message 502.

### Augmented Reality Shared Screen Space

FIG. 6 illustrates a system 600 for an augmented reality (AR) shared screen space. The system 600 includes an AR wearable device 602 such as glasses 1100 of FIG. 11. The AR wearable device 602 and AR wearable devices 692 may be mixed reality devices or virtual reality devices. The system 600 includes AR wearable device 602, real-world scene 680, which is what the user 698 sees of the world, backend 690, AR wearable devices 692, which are the AR wearable devices 692 of the other users 628, and user 698, which is the user 698 of the “Host” AR wearable device 602. The session module 621 enables the user 698 to share a screen 644 with other users 628 using their other or “Guest” AR wearable devices 692.

The input/output (IO) devices 604 include devices that enable a user 698 to receive output or provide input to the system 600. The IO devices 604 include a microphone 606, a display 608, a speaker (not illustrated), an image capturing device 610, a button 612, a touchpad 614, a gyroscope (not illustrated), and so forth. The image capturing device 610 captures the image 622 of the real-world scene 680 which is a front facing view of the user view 609, which is what the user 698 sees through the AR wearable device 602, in accordance with some examples. For example, the user 698 may look through optical elements 1143, 1144 (or lenses) of FIG. 11 to see the user view 609 of the real-world scene 680. The location 611 is a location of the user 698. In some examples, the location 611 is in 3D coordinates within a 3D world coordinate system that indicates a location of the user view 609. In some examples, the location 611 indicates a relative location of the user 698 to the screen 644. The image capturing device 610 may be charged-coupled device (CCD) or another type of device to capture an image of the real-world scene 680. An example of button 612 is button 1178 of FIG. 11. An example of the touchpad 614 is touchpad 1176. The button 612 and touchpad 614 enable the user 698 to provide haptic 601 input. The microphone 606 enables the user 698 to provide voice 605 input. The image capturing device 610 enables the user 698 to provide gesture 603 input via the UI module 658, which processes or analyzes the images 622 to determine the gesture 603 and the user intent 664 based on the analysis of the images 622.

The sensors 616 includes a gyroscope, light sensor, a positioning sensor, a clock, and so forth. An example gyroscope is gyroscopes 1180 of FIG. 11. Some devices such as a gyroscope can be both a sensor 616 and an IO device 604. For example, the user 698 may move the AR wearable device 602, which changes the position 607 of the user 698 and communicates input to the AR wearable device 602. The position 607 of the user 698 is assumed to be the same as the AR wearable device 602, in accordance with some examples. The AR wearable device 602 detects the change in position 607 using a sensor 616 such as a gyroscope or another sensor to detect the change of position 607 of the user 698. The movement of the user 698 may have a user intent 664 to communicate input to the AR wearable device 602, for example a nod or shake of the head. However, the user 698 may move with the AR wearable device 602 without a user intent 664 to communicate input to the AR wearable device 602.

The wireless module 624 communicates 618 between the AR wearable devices 602 and the AR wearable devices 692 and communicates 694 between the AR wearable device 602 and the other AR wearable devices 692. In some examples, the wireless module 624 communicates with the other AR wearable devices 692 via the backend 690. The wireless module 624 is configured to perform wireless communication protocols with the backend 690 and the other AR wearable devices 692. The communication protocols may include LE Bluetooth, Institute for Electrical and Electronic Engineers (IEEE) 802.11 communication protocols, proprietary communications protocols, 3GPP communication protocols, and so forth. The wireless module 624 is configured to communicate using one or more higher-level protocols such as TCP/IP and so forth. The wireless module 624 sets up a wireless communication link between the AR wearable device 602 and the backend 690 and between the AR wearable device 602 and the other AR wearable devices 692. For example, the wireless module 624 associates with a corresponding wireless module on the backend 690. The wireless module 624 may communicate with the backend 690 or the other AR wearable devices 692 via another intermediate device such as a user device 102, which may also be the backend 690, an access point, a node B, or another wireless device.

In some examples, the wireless module 624 can be used to determine a location and/or an orientation of the AR wearable device 602 with the assistance of other wireless devices. The other AR wearable devices 692 may be local or close to the AR wearable device 602 and the AR wearable device 602 may communicate via low energy Bluetooth® (BLE). In some examples, the AR wearable device 602 communicates with the other AR wearable devices 692 via a user device 102 such as a paired mobile phone. If an AR wearable device 692 is remote, then the wireless module 624 sets up a communication 694 link between the AR wearable device 602 and the backend 690, which has a communication 695 link between the backend 690 and the other AR wearable device 692. The communication 694 link and communication 695 link may be via one or more other devices such as user devices 102, the messaging server system 108, and/or the internet.

The user 666 is data that is related to the user 698. The information 668 includes input data from the user 698 and may include additional information about the user 698 such as a social media account to log onto the messaging server system 108, a username, and so forth.

The user interface (UI) module 658 presents a UI 662 that includes an item 660 that when selected by the user 698 indicates a user intent 664 of the user 698. The user 666 is the data indicating the input of the user 698.

The state 623 is stored in a memory of the AR wearable device 602 and indicates a state of the shared screen module 625. The states 623 include “Sharing”, “Inactive”, and “Connecting”. In the “Sharing” state 623 the shared screen module 625 is either a “Host” or “Guest” where when acting as “Host” the shared screen module 625 shares the shared screen 642 and in “Guest” state the shared screen module 625 receives a shared screen 642 from a “Host” shared screen module 625.

The “Inactive” state 623 indicates that the shared screen module 625 is not active or not currently sharing a shared screen 642. The “Connecting” state 623 indicates that the session module 621 is connecting with one or more other wearable device 692 to enter the “Sharing” state 623 as either a “Host” or “Guest”. The other or “Guest” AR wearable devices 692 can either be remote or local, which is indicated by remote 636.

In some examples, the user 698 indicates that they would like to share a shared screen 642 with another user 628 of a “Guest” AR wearable device 692. The user 628 includes data about other or “Guest” users 628. The “Host” user 698 may have a user 628 field as well.

The user 698 selects an item 660 indicating a user intent 664 to share a shared screen 642 with the other user 628. The session module 621 connects with the “Guest” AR wearable device 692 either locally or remotely. The “Guest” user 628 of the “Guest” AR wearable device 692 either accepts the request to share a screen 642 or rejects the request to share the screen 642. In some examples, the “Guest” user 628 may be using a computing device such as a client device 102 and not a “Guest” AR wearable device 692. In these examples, the avatar 638 may indicate that the “Guest” user 628 cannot move and the avatar 638 may be placed in a suitable location relative to the shared screen 642. The user 628 may still be able to add augmentations 650 such as on a touch screen.

If the “Guest” user 628 indicates they would like to share a shared screen 642, then the session module 621 sends a shared screen 642, augmentations 650, and avatar 638 to the “Guest” AR wearable device 692. And the state 623 for the “Host” user 698 becomes “Sharing” as “Host” and the state 623 for the “Guest” user 628 become “Sharing” as “Guest”. Similarly, other “Guest” users 628 may be added by the session module 621.

In some examples, the AR wearable device 602 acting as “Host” receives the avatar 638 and augmentations 650 from all the “Guest” AR wearable devices 602 and forwards them to the other “Guest” AR wearable devices 692. Additionally, the “Host” shares augmentations 650 that the “Host” AR wearable device 602 has created as well as an avatar 638 for the “Host” user 698. In some examples, the “Guest” AR wearable device 692 send the avatar 638 and augmentations 650 information to one another. In some examples, a combination is used where some “Guest” AR wearable devices 692 send the avatar 638 and augmentations 650 to the “Host” AR wearable device 602 only and other “Guest” AR wearable device 692 send the avatar 638 and augmentations 650 to one another.

The shared screen 642 may be the display 608 of the “Host” AR wearable device 602, a physical screen in a room with the user 698, a virtual display created by the AR graphics module 620, or a display (not illustrated) of another device such as a computing device that the user 698 is controlling. If the shared screen 642 requires that the AR wearable device 602 capture images 622 to share the shared screen 642, then the AR graphics module 620 causes images 622 to be captured by the image capturing device 610. For example, if the shared screen 642 is a whiteboard in an office such as screen 682 in the real-world scene 680, then the shared screen 642 is the screen 682 and the AR graphics module 620 captures images 622 via light 686 of the real-world scene 680 in accordance with a user view 609.

In some examples, the AR graphics module 620 in the “Sharing” state 623 as “Host” extracts the screen 644 from the image 622 where the screen 644 is screen 682 and then the screen 644 is used as shared screen 642. Extracting the screen 644 from the image 622 reduces the amount of data that has to be sent to the other AR wearable devices 692. In some examples, the entire image 622 may be sent to the other AR wearable devices 692. In the case when the shared screen 642 is what the user 698 sees through the AR wearable device 602, then the AR graphics module 620 captures images 622 and integrates what is displayed on the display 608 with the image 622 and uses the integrated images 622 as the shared screen 642. In the case where another computing device is generating the shared screen 642, then the session module 621 directs a feed of the screen of the computing device to be sent to the other AR wearable device 602 with an indication of a location 646 and size 648 for the shared screen 642. For example, if the AR wearable device 602 is in a state of “Sharing” as the “Host” and shares a display of their desktop computer, then the session module 621 directs a feed of the screen of the desktop computer to be sent to the other AR wearable device 692 where this may be through the AR wearable device 602 or through another route such as the internet. Alternatively, the screen of the desktop computer may be captured by images 622 and extracted as the screen 644 as disclosed herein. When the shared screen 642 is a virtual shared screen 642 then the AR graphics module 620 generates the screen characteristics such as size 648 and location 646 which may be selected by the user 698. The shared screen 642, in this case, is an indication of a virtual screen. In some examples, the AR graphics module 620 extracts the user 645 from the image 622 and generates an avatar 638 for the user 645. In these examples, the user 683 may not be wearing an AR wearable device 692 but the “Host” AR wearable device 602 would like to make the other users 628 of the “Guest” AR wearable device 692 aware of the presence of the users 683 in the real-world scene 680 without “Guest” AR wearable devices 692.

The AR graphics module 620 determines a location 646 and a size 648 of the shared screen 642. For example, the AR graphics module 620 may determine the size 648 and location 646 based on a 3D world coordinate system that enables the AR graphics module 620 to determine the size of the screen 682 in the real-world scene 680 based on its location 646 and location 611 of the user 698. In some examples, the user 698 selects the size 648 and location 646 of the shared screen 642 via the UI module 658. In some examples, the “Guest” users 628 can adjust the location 646 and size 648 of the shared screen 642 for their display where the AR graphics module 620 adjusts the size 648 to maintain relative proportions.

In some examples, an ML module 649, 688 is a neural network trained to identify the screen 644 in the image 622 and identify its location 646. The AR graphics module 620 may determine whether to process the images 622 locally or by a backend 690 such as the user device 102.

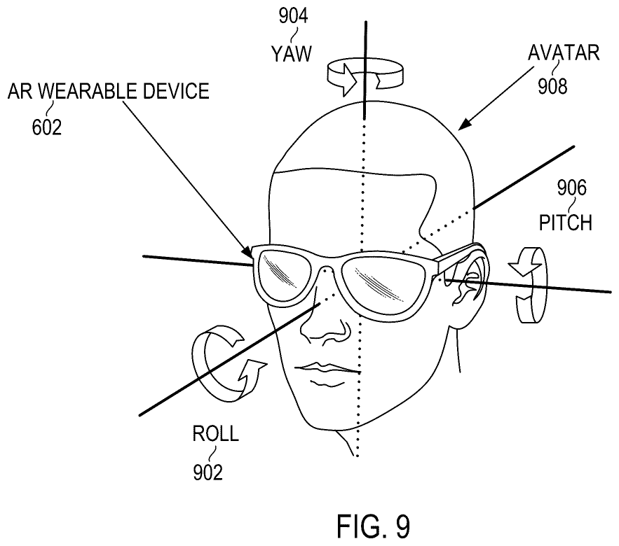

The AR graphics module 620 determines the avatar 638 information for both the “Guest” users 628 and the “Host” user 698. For example, the relative location 630 is based on the location 611 of the user 683 in relation to the shared screen 642. The AR graphics module 620 determines the head orientation 634 based on, referring to FIG. 9, analyzing one or more of a yaw 904, a roll 902, and pitch 906 of a head of the user 698. The yaw 904, roll 902, and pitch 906 may be determined based on data from the sensors 616 or based on the AR graphics module 620 analyzing images 622 where one or more reference points are used to determine the yaw 904, the roll 902, and the pitch 906. In some examples, only one or two of yaw 904, roll 902, and pitch 906 are determined.

The AR graphics module 620 adjusts a shape of the avatar 638 based on the location 646 of the shared screen 642, the location 611 of the AR wearable device 602 relative to the location 646 of the shared screen 642, and a user view 609 of the user 698 of the AR wearable device 602.

The AR graphics module 620 determines the eye projection 632 based on a relative location 630 of the user 628 and their head orientation 634. The eye projection 632 is where the user 628 or user 698 appears to be looking at the shared screen 642. The avatar data 637 may be a default avatar data 637 or may be an avatar data 637 associated with the user 628 or user 698 where the user 628 or user 698 may send the avatar data 637 to the AR wearable device 602 or the AR graphics module 620 may retrieve the avatar data 637 from a backend 690 such as the messaging server system 108.

The augmentations 650 are a graphic 656 added at a location 652 to the shared screen 642 by a user 654, in accordance with some examples. The user 654 may be a “Guest” user 628 or a “Host” user 698. The graphic 656 may be an emoji such as a “thumbs up”, a hand drawn line or lines, an image to be shared, or other data that can be displayed on the display 608 as if it was added to the shared screen 642. In some examples, the augmentation 650 may indicate a movement of the avatar 638 of the user 628 in response to movement of, or other input by, the user 628. For example, the “thumbs up” may be performed by the avatar 638 of the user 628 when the avatar 638 includes arms and hands. Other examples, include a “nod” where the avatar 638 of the user 628 nods and a “no” where the avatar 638 of the user 628 shakes its head from left to right.

The session 626 indicates the data being generated for a sharing session 626. In some examples, the session module 621 in a state 623 of “Sharing” as “Host” sends to the “Guest” AR wearable devices 692 the augmentations 650, the shared screen 642, and the avatars 638. In some examples, the session module 621 in a state of “Sharing” as “Guest” sends augmentations 650 newly generated by the user 628 and the avatar 638 of the user 628. Communications difficulties may be reduced by having the session module 621 in a state 623 of “Sharing” as “Host” forward the augmentations 650 and avatars 638 of the other users 628 to each of the “Guest” AR wearable device 692. In some examples, the AR graphics module 620 merges the augmentations 650 with the shared screen 642 so that only the shared screen 642 needs to be sent to the other AR wearable device 692. The audio 640 is shared and played for users 628 that are not local as indicated in remote 636.

In some examples, the session module 621 in a state 623 of “Sharing” as “Host” sends the shared screen 642 to the “Guest” users 628. The shared screen 642 may have been extracted from an image 622 and be, for example, screen 682. The AR graphics module 620 in a state of “Sharing” as “Guest” may display the shared screen 642 on the display 608. The AR graphics module 620 may maintain a copy of the shared screen 642 and continue to display the copy of the shared screen 642 until a new valid shared screen 642 is sent. For example, the user 698 of the “Host” AR wearable device 602 may move their head so they are no longer facing the shared screen 642 or they may move to a position that obscures the shared screen 642. The AR graphics module 620 in the state of “Sharing” as “Guest” may continue to display the stored shared screen 642 while updating the display 608 based on updates of augmentations 650 and avatars 638.

The term AR graphics includes anything displayed by the AR wearable device 602 on the display 608 for the user 698 to view in conjunction with viewing the real world through lenses. Alternatively, the user 698 may view the real world by the AR wearable device 602 capturing images 622 and displaying the images 622 and the AR graphics on an opaque display 608.

The AR graphics module 620 in a state 623 of “Sharing” as “Guest” displays the shared screen 642, the augmentations 650, and the avatars 638 on the display 608 of the AR wearable device 602 for the user 698 to view in conjunction with viewing the user view 609 of the real-world scene 680. If a user 628 is indicated as being local in remote 636, then the avatar 638 of the user 628 is not displayed, in accordance with some examples.

In some examples, the AR graphics module 620 projects or adjusts the augmentations 650, shared screen 642, and avatars 638 to be in a proper perspective for the location 652, location 646, and relative location 630 based on the location 611 of the user view 609. For example, the AR graphics module 620 adjusts the size of an augmentation 650 to appear to be at the location 652 on the shared screen 642 with a proper orientation. The location 646, location 652, and relative location 630 may be in a 3D world coordinate system of the AR wearable device 602 where relative values are shared with other AR wearable device 692. In some examples, the AR graphics module 620 adjusts the location 646 of the shared screen 642 to remain in front position of the user 698. For example, when the shared screen 642 is not a physical screen 682 seen through the AR wearable device 602, then the shared screen 642 and the placement of the avatars 638 and the augmentation 650 are shifted in accordance with the shared screen 642 remaining in a front position as the user 698 turns.

The AR graphics module 620 in a state 623 of “Sharing” as “Host” displays the augmentations 650 and the avatars 638 on the display 608 of the AR wearable device 602 for the user 698 to view in conjunction with viewing the user view 609 of the real-world scene 680. If a user 628 is indicated as being local in remote 636, then the avatar 638 of the user 628 is not displayed, in accordance with some examples. The shared screen 642 may be the display 608 of the AR wearable device 602 in which case the avatars 638 are not included as part of the shared screen 642.

In some examples, the session module 621 in a state 623 of “Sharing” as “Guest” sends avatar 638 and augmentation 650 updates to the AR wearable device 602 acting as the “Host” and to the AR wearable devices 692 acting as “Guests.” The session module 621 may adjust a rate of sending updates for the avatars 638 so that the movement of the avatars 638 may be captured by the other AR wearable devices 692. For example, the session module 621 may send updates to the avatar 638 multiple times a second such as 10 to 30 times a second.

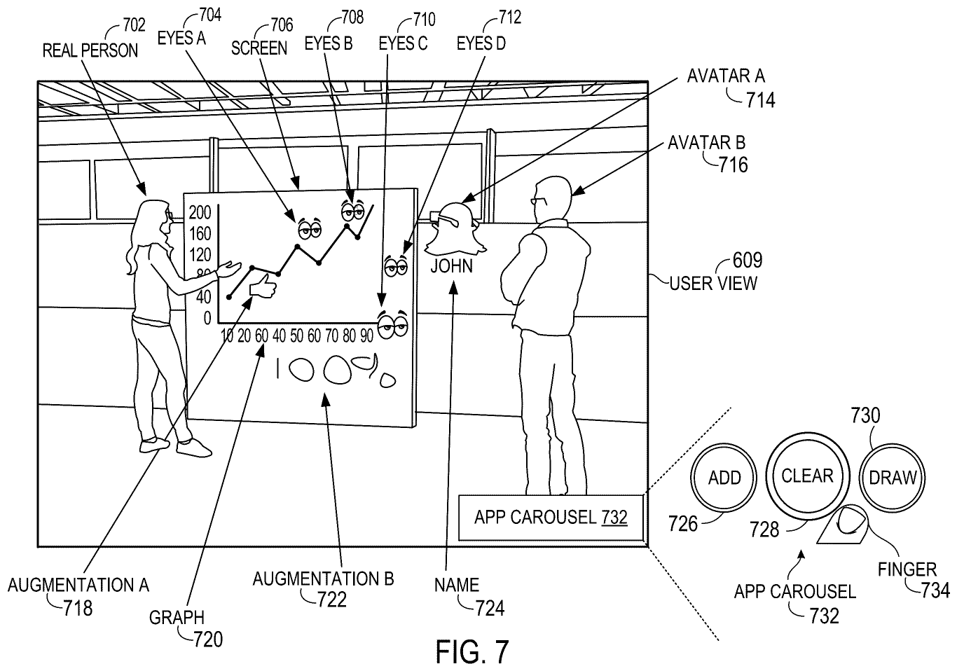

FIG. 7 illustrates an AR shared screen space, in accordance with some examples. The user view 609 is what user 698 see through the AR wearable device 602. In this case the AR wearable device 602 is acting as the “Host”. The screen 706 is a real whiteboard. The real person 702 is a user 683 that the user 698 is seeing through the lenses of the AR wearable device 602. The real person 702 is indicated as local in remote 636. The real person 702 has an avatar 638 that is shared with and used by the AR wearable devices 692 of avatar A 714 and avatar B 716. In some examples, the real person 702 is shared with the AR wearable devices 692 of avatar A 714 and avatar B 716 through the image 622. However, the users 628 corresponding to avatar A 714 and avatar B 716 may not be able to see the real person 702 if the user 698 of the user view 609 turns their head or moves.

The AR graphics module 620 displays avatar A 714 and avatar B 716 in accordance with the position and orientation of corresponding avatar 638. The positions of avatar A 714 and avatar B 716 will change in accordance with movement of the users 628 corresponding to avatar A 714 and avatar B 716. The head of avatar A 714 and avatar B 716 are displayed by the AR graphics module 620 in accordance with the head orientation 634. The updates to the avatar 638 may be often enough so that if the user 628 corresponding to avatar A 714 shook their head “no” that the avatar A 714 would shake its head “no” in an identifiable way with little or no perceptible delay.

Avatar A 714 does not have special avatar data 637 so default avatar data 637 is used. Avatar B 716 does have customized avatar data 637, which is used and may be an actual representation of the user 628 corresponding to avatar B 716. Avatar A 714 includes a name 724 of “John”. Avatar B 716 does not include a name because it is customized avatar data 637. In some examples, real person 702 and avatar B 716 include names. In some examples, avatar A 714 does not include a name.

Eyes A 704 is an indication of where the eyes of the real person 702 are looking. Eyes B 708 is an indication of where the eyes of the avatar B 716 are looking. Eyes C 710 is an indication of where the eyes of the user 698 are looking. Eyes D 712 is an indication of where the eyes of the avatar A 714 are looking.

Augmentation A 718 is a “Thumbs Up” emoji, which may include an indication of which of the users 628 or the user 698 added augmentation A 718. Augmentation A 718 is an example of augmentation 650. The AR graphics module 620 adjusts the size and orientation of augmentation A 718 to appear to be on the screen 706. The graph 720 may have been on the screen 706 as a real drawing on the screen 706 or it may be an augmentation 650. Augmentation B 722 is a drawing of “100%”.

The app carousel 732 is a UI 662. “Add” 726, “Clear” 728, and “Draw” 730 are items 660. The finger 734 is the finger of the user 698. An item 660 is selected by the user 698 by moving their finger 734 over an item 660 and holding it there for a predetermined time. The UI module 658 then interprets the holding of the finger 734 over an item 660 to be a user intent 664 to select the item 660. The UI module 658 processes the images 622 to determine the position of the finger 734. Holding the finger 734 over an item 660 is an example of a gesture 603. The “Add” 726 may enable the user 698 to add another user 628. The “Clear” 728 may clear the screen 706 of one or more augmentations 650. The “Draw” 730 may enable the user 698 to add an augmentation 650, which may include selecting a screen shot of another device, or another image. For example, the graph 720 may be an augmentation 650 of an image that was added by the user 698 or another user 628.

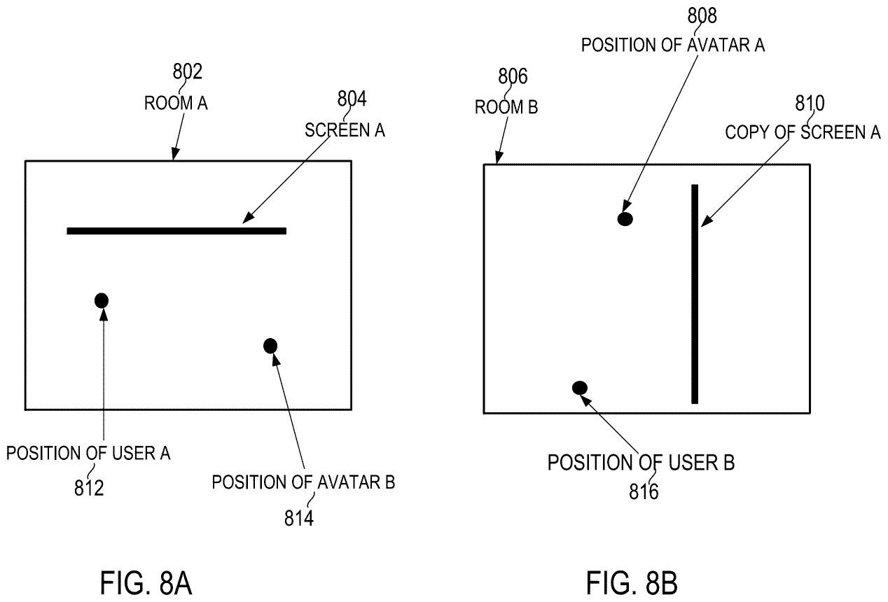

FIGS. 8A and 8B illustrate positions of the avatars, in accordance with some examples. Position of user A 812 illustrates a location 611 of the user 698 in Room A 802. The user 698 is in Room A 802 with screen A 804. The user 698 shares screen A 804 as shared screen 642 and sends an avatar 638 to the AR wearable device 692 of user B. The avatar 638 includes relative location 630 of user A relative to the shared screen 642, which in this illustration is screen A 804. The shared screen 642 includes a location 646 but user B may determine not to use the location 646. The AR wearable device 692 of user B displays a copy of screen A 810 on the display 608 of the AR wearable device 692 in a different location in room B 806. User B is at position of user B 816. The AR graphics module 696 can display the avatar of user A at position of avatar A 808 because the relative location 630 is based on where the shared screen 642, which here is copy of screen A 810, is displayed in room B 806. The AR wearable device 692 of user B sends an avatar 638 of user B to the AR wearable device 602 of user A. The AR graphics module 620 displays the avatar of user B at a position of avatar B 814 based on the relative location 630 of the avatar 638 for user B to copy of screen A 810. So, the AR graphics module 620 can keep the spatial relationships the relative even when the shared screen 642 is oriented differently.

FIG. 9 illustrates yaw, roll, and pitch, in accordance with some examples. The roll 902, yaw 904, and pitch 906 may be determined by the AR wearable device 602 as disclosed herein. The avatar 908 may be displayed in accordance with the determined roll 902, yaw 904, and pitch 906 of the corresponding user 698 of the AR wearable device 602. In some examples, only one or two of the roll 902, the yaw 904, and the pitch 906 are determined.

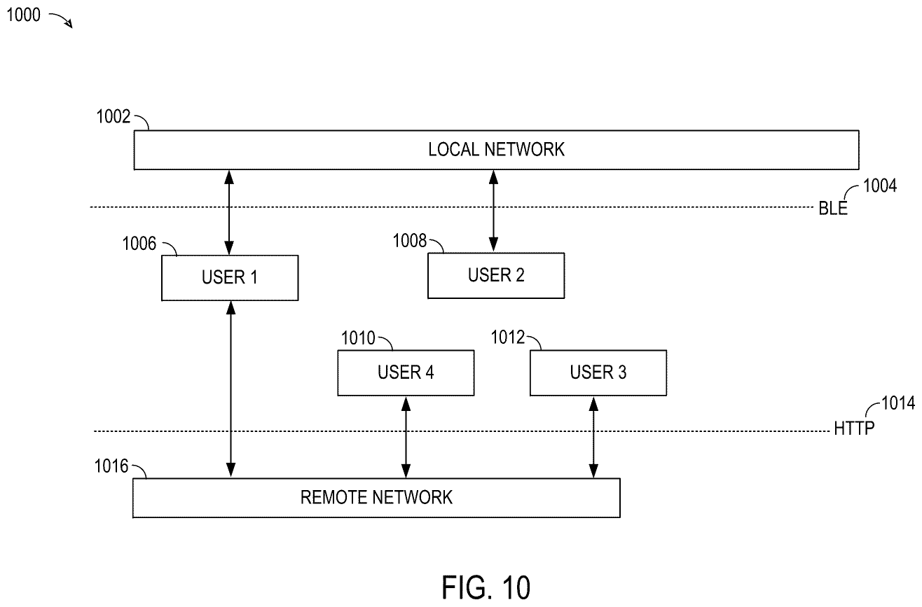

FIG. 10 illustrates communications 1000 for AR shared screen space. A remote network 1002 such as the internet, 3GPP, and so forth is used to send HTTP 1014 messages among user 1 1006, user 4, and user 3 1012. User 1 1006 is AR wearable device 602. User 2 1008, user 3 1012, and user 4 1010 are AR wearable devices 692, in accordance with some examples.

User 4 1010 and user 3 1012 are “remote” players in the context of the AR shared screen space. During “remote” play an audio channel is established to share audio 640 data among user 1 1006, user 2 1008, user 3 1012, and user 4 1010. User 1 1006 and user 2 1008 do not need to share audio 640 data as they are “local” to one another.

The local network 1002 uses a wireless protocol such as BLE 1004 to connect user 1 1006 and user 2 1008 locally. For example, user 1 1006 and user 2 1008 may all be in the same room. In some examples, one or more of user 1 1006, user 2 1008, user 3 1012, and user 4 1010 are user devices 102 that then relay the messages to AR wearable device 602 or AR wearable devices 692 using a communication protocol such as BLE.

In some examples, user 1 1006 is the “Host” and user 2 1008, user 3 1012, and user 4 1010 are the “Guests”. User 2 1008, user 3 1012, and user 4 1010 send their avatars 638 and augmentations 650 to user 1 1006 and user 1 1006 handles sending all the augmentations 650 and avatars 638 to user 2 1008, user 3 1012, and user 4 1010. Additionally, user 1 1006 sends the shared screen 642 and the avatar 638 and augmentations 650 of user 1 1006 to user 2 1008, user 3 1012, and user 4 1010. In some examples, each user such as user 2 1008 sends their avatar 638 and augmentations 650 to each of the other users. In some examples, the shared screen 642, augmentations 650, and/or avatars 638 are sent through a central server such as messaging server system 108 or through the internet to the other users.

The wireless module 624 of FIG. 6 is configured to communicate both over the remote network 1016 and over the local network 1002. Additionally, the wireless module 624 may relay communications via one or more other devices such as the backend 690, an access point, an eNodeB, or the internet.

FIG. 11 is a perspective view of a wearable electronic device in the form of glasses 1100, in accordance with some examples. The glasses 1100 are an article of eyewear including electronics, which operate within a network system for communicating image and video content. In some examples, the wearable electronic device is termed AR glasses. The glasses 1100 can include a frame 1132 made from any suitable material such as plastic or metal, including any suitable shape memory alloy. The frame 1132 can have a front piece 1133 that can include a first or left lens, display, or optical element holder 1136 and a second or right lens, display, or optical element holder 1137 connected by a bridge 1138. The front piece 1133 additionally includes a left end portion 1141 and a right end portion 1142. A first or left optical element 1144 and a second or right optical element 1143 can be provided within respective left and right optical element holders 1136, 1137. Each of the optical elements 1143, 1144 can be a lens, a display, a display assembly, or a combination of the foregoing. In some examples, for example, the glasses 1100 are provided with an integrated near-eye display mechanism that enables, for example, display to the user of preview images for visual media captured by cameras 1169 of the glasses 1100.

The frame 1132 additionally includes a left arm or temple piece 1146 and a right arm or temple piece 1147 coupled to the respective left and right end portions 1141, 1142 of the front piece 1133 by any suitable means such as a hinge (not shown), so as to be coupled to the front piece 1133, or rigidly or fixedly secured to the front piece 1133 so as to be integral with the front piece 1133. Each of the temple pieces 1146 and 1147 can include a first portion 1151 that is coupled to the respective end portion 1141 or 1142 of the front piece 1133 and any suitable second portion 1152, such as a curved or arcuate piece, for coupling to the ear of the user. In one example, the front piece 1133 can be formed from a single piece of material, so as to have a unitary or integral construction. In one example, the entire frame 1132 can be formed from a single piece of material so as to have a unitary or integral construction.

The glasses 1100 include a computing device, such as a computer 1161, which can be of any suitable type so as to be carried by the frame 1132 and, in one example of a suitable size and shape, so as to be at least partially disposed in one or more of the temple pieces 1146 and 1147. In one example, the computer 1161 has a size and shape similar to the size and shape of one of the temple pieces 1146, 1147 and is thus disposed almost entirely if not entirely within the structure and confines of such temple pieces 1146 and 1147.

In one example, the computer 1161 can be disposed in both of the temple pieces 1146, 1147. The computer 1161 can include one or more processors with memory, wireless communication circuitry, and a power source. The computer 1161 comprises low-power circuitry, high-speed circuitry, location circuitry, and a display processor. Various other examples may include these elements in different configurations or integrated together in different ways. Additional details of aspects of the computer 1161 may be implemented as described with reference to the description that follows.

The computer 1161 additionally includes a battery 1162 or other suitable portable power supply. In one example, the battery 1162 is disposed in one of the temple pieces 1146 or 1147. In the glasses 1100 shown in FIG. 11, the battery 1162 is shown as being disposed in the left temple piece 1146 and electrically coupled using a connection 1174 to the remainder of the computer 1161 disposed in the right temple piece 1147. One or more input and output devices can include a connector or port (not shown) suitable for charging a battery 1162 accessible from the outside of the frame 1132, a wireless receiver, transmitter, or transceiver (not shown), or a combination of such devices.

The glasses 1100 include digital cameras 1169. Although two cameras 1169 are depicted, other examples contemplate the use of a single or additional (i.e., more than two) cameras 1169. For ease of description, various features relating to the cameras 1169 will be described further with reference to only a single camera 1169, but it will be appreciated that these features can apply, in suitable examples, to both cameras 1169.

In various examples, the glasses 1100 may include any number of input sensors or peripheral devices in addition to the cameras 1169. The front piece 1133 is provided with an outward-facing, forward-facing, front, or outer surface 1166 that faces forward or away from the user when the glasses 1100 are mounted on the face of the user, and an opposite inward-facing, rearward-facing, rear, or inner surface 1167 that faces the face of the user when the glasses 1100 are mounted on the face of the user. Such sensors can include inward-facing video sensors or digital imaging modules such as cameras 1169 that can be mounted on or provided within the inner surface 1167 of the front piece 1133 or elsewhere on the frame 1132 so as to be facing the user, and outward-facing video sensors or digital imaging modules such as the cameras 1169 that can be mounted on or provided with the outer surface 1166 of the front piece 1133 or elsewhere on the frame 1132 so as to be facing away from the user. Such sensors, peripheral devices, or peripherals can additionally include biometric sensors, location sensors, accelerometers, or any other such sensors. In some examples, projectors (not illustrated) are used to project images on the inner surface of the optical elements 1143, 1144 (or lenses) to provide a mixed reality or augmented reality experience for the user of the glasses 1100.

The glasses 1100 further include an example of a camera control mechanism or user input mechanism comprising a camera control button mounted on the frame 1132 for haptic or manual engagement by the user. The camera control button provides a bi-modal or single-action mechanism in that it is disposable by the user between only two conditions, namely an engaged condition and a disengaged condition. In this example, the camera control button is a push button that is by default in the disengaged condition, being depressible by the user to dispose it to the engaged condition. Upon release of the depressed camera control button, it automatically returns to the disengaged condition.

In other examples, the single-action input mechanism can instead be provided by, for example, a touch-sensitive button comprising a capacitive sensor mounted on the frame 1132 adjacent to its surface for detecting the presence of a user's finger, to dispose the touch-sensitive button to the engaged condition when the user touches a finger to the corresponding spot on the outer surface 1166 of the frame 1132. It will be appreciated that the above-described camera control button and capacitive touch button are but two examples of a haptic input mechanism for single-action control of the camera 1169, and that other examples may employ different single-action haptic control arrangements.

The computer 1161 is configured to perform the methods described herein. In some examples, the computer 1161 is coupled to one or more antennas for reception of signals from a GNSS and circuitry for processing the signals where the antennas and circuitry are housed in the glasses 1100. In some examples, the computer 1161 is coupled to one or more wireless antennas and circuitry for transmitting and receiving wireless signals where the antennas and circuitry are housed in the glasses 1100. In some examples, there are multiple sets of antennas and circuitry housed in the glasses 1100. In some examples, the antennas and circuitry are configured to operate in accordance with a communication protocol such as Bluetooth™, Low-energy Bluetooth™, IEEE 802, IEEE 802.11az/be, and so forth. In some examples, PDR sensors housed in glasses 1100 and coupled to the computer 1161. In some examples, the glasses 1100 are VR headsets where optical elements 1143, 1144 are opaque screens for displaying images to a user of the VR headset. In some examples, the computer 1161 is coupled to user interface elements such as slide or touchpad 1176 and button 1178. A long press of button 1178 resets the glasses 1100. The slide or touchpad 1176 and button 1178 are used for a user to provide input to the computer 1161 and/or other electronic components of the glasses 1100. The glasses 1100 include one or more microphones 1182 that are coupled to the computer 1161. The glasses 1100 include one or more gyroscopes 1180.

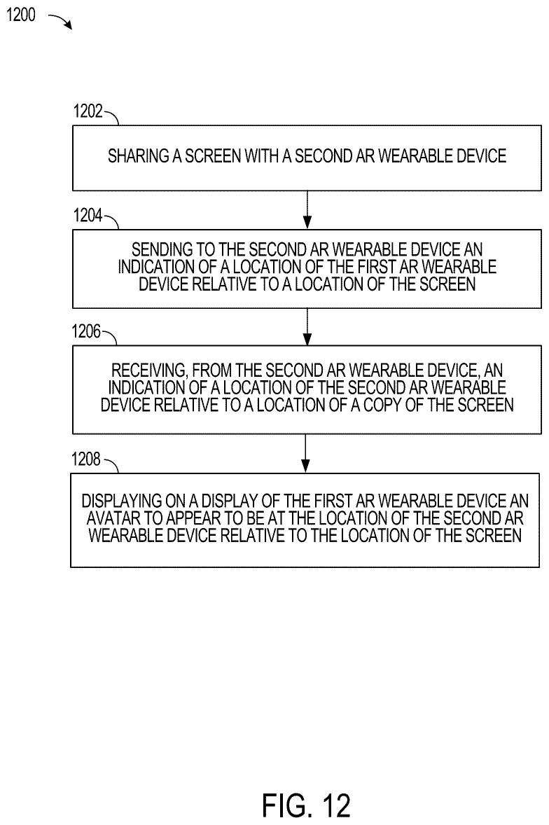

FIG. 12 illustrates a method 1200 for an augmented reality shared screen space, in accordance with some examples. The method 1200 begins at operation 1202 with sharing a screen with a second AR wearable device. For example, AR wearable device 602 shares the shared screen 642 with AR wearable device 692.

The method 1200 continues at operation 1204 with sending to the second AR wearable device an indication of a location of the first AR wearable device relative to a location of the screen. For example, AR wearable device 602 sends to AR wearable device 692 location 646 of the shared screen 642 and relative location 630 of user 698 to the shared screen 642.

The method 1200 continues at operation 1206 with receiving, from the second AR wearable device, an indication of a location of the second AR wearable device relative to a location of a copy of the screen. For example, AR wearable device 602 receives from AR wearable device 692 relative location 630 of the AR wearable device 692 to the shared screen 642 being displayed on the display 608 of the AR wearable device 692.

The method 1200 continues at operation 1208 with displaying on a display of the first AR wearable device an avatar to appear to be at the location of the second AR wearable device relative to the location of the screen. For example, AR graphics module 620 displays on the display 608 an avatar 638 at a relative location 630 to the shared screen 642.

The method 1200 may include one or more additional operations. Operations of method 1200 may be performed in a different order. One or more of the operations of method 1200 may be optional. The method 1200 may be performed by the client device 102, system 600, an apparatus of the glasses 1100, or another electronic device. Portions of the functionality may be performed on a server computer or host computer. For example, glasses 1100 may be coupled to a host client device 102 or application server 114 where one or more of the operations are performed.

### Machine Architecture

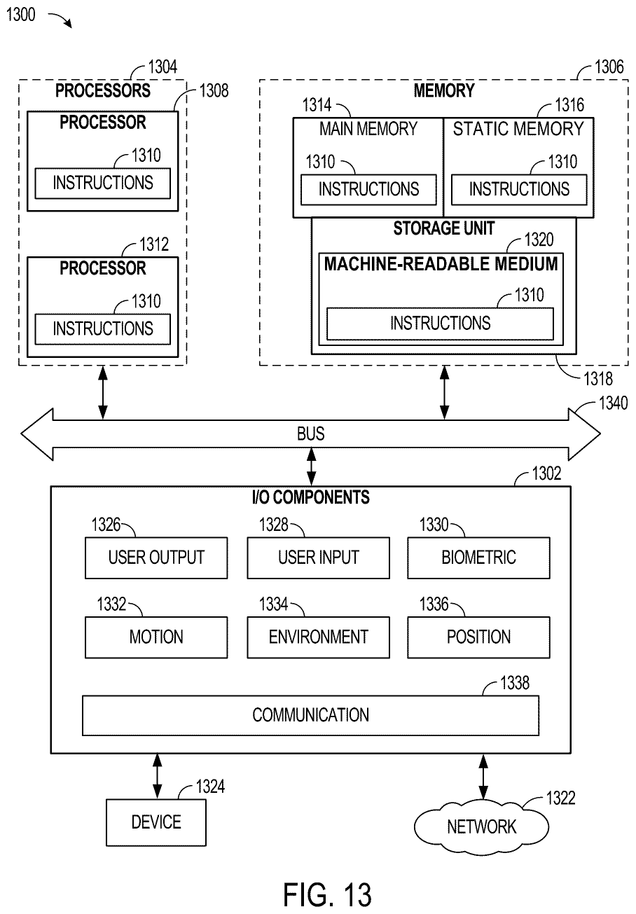

FIG. 13 is a diagrammatic representation of the machine 1300 within which instructions 1310 (e.g., software, a program, an application, an applet, an app, or other executable code) for causing the machine 1300 to perform any one or more of the methodologies discussed herein may be executed. For example, the instructions 1310 may cause the machine 1300 to execute any one or more of the methods described herein. The instructions 1310 transform the general, non-programmed machine 1300 into a particular machine 1300 programmed to carry out the described and illustrated functions in the manner described. The machine 1300 may operate as a standalone device or may be coupled (e.g., networked) to other machines. In a networked deployment, the machine 1300 may operate in the capacity of a server machine or a client machine in a server-client network environment, or as a peer machine in a peer-to-peer (or distributed) network environment. The machine 1300 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1310, sequentially or otherwise, that specify actions to be taken by the machine 1300. Further, while only a single machine 1300 is illustrated, the term “machine” shall also be taken to include a collection of machines that individually or jointly execute the instructions 1310 to perform any one or more of the methodologies discussed herein. The machine 1300, for example, may comprise the client device 102 or any one of a number of server devices forming part of the messaging server system 108. In some examples, the machine 1300 may also comprise both client and server systems, with certain operations of a particular method or algorithm being performed on the server-side and with certain operations of the particular method or algorithm being performed on the client-side.

The machine 1300 may include processors 1304, memory 1306, and input/output I/O components 1302, which may be configured to communicate with each other via a bus 1340. In an example, the processors 1304 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1308 and a processor 1312 that execute the instructions 1310. The term “processor” is intended to include multi-core processors that may comprise two or more independent processors (sometimes referred to as “cores”) that may execute instructions contemporaneously. Although FIG. 13 shows multiple processors 1304, the machine 1300 may include a single processor with a single-core, a single processor with multiple cores (e.g., a multi-core processor), multiple processors with a single core, multiple processors with multiples cores, or any combination thereof.

The memory 1306 includes a main memory 1314, a static memory 1316, and a storage unit 1318, both accessible to the processors 1304 via the bus 1340. The main memory 1306, the static memory 1316, and storage unit 1318 store the instructions 1310 embodying any one or more of the methodologies or functions described herein. The instructions 1310 may also reside, completely or partially, within the main memory 1314, within the static memory 1316, within machine-readable medium 1320 within the storage unit 1318, within at least one of the processors 1304 (e.g., within the Processor's cache memory), or any suitable combination thereof, during execution thereof by the machine 1300.

The I/O components 1302 may include a wide variety of components to receive input, provide output, produce output, transmit information, exchange information, capture measurements, and so on. The specific I/O components 1302 that are included in a particular machine will depend on the type of machine. For example, portable machines such as mobile phones may include a touch input device or other such input mechanisms, while a headless server machine will likely not include such a touch input device. It will be appreciated that the I/O components 1302 may include many other components that are not shown in FIG. 13. In various examples, the I/O components 1302 may include user output components 1326 and user input components 1328. The user output components 1326 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1328 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1302 may include biometric components 1330, motion components 1332, environmental components 1334, or position components 1336, among a wide array of other components. For example, the biometric components 1330 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1332 include acceleration sensor components (e.g., accelerometer), gravitation sensor components, rotation sensor components (e.g., gyroscope).

The environmental components 1334 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 102 may have a camera system comprising, for example, front cameras on a front surface of the client device 102 and rear cameras on a rear surface of the client device 102. The front cameras may, for example, be used to capture still images and video of a user of the client device 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 102 may also include a 3600 camera for capturing 360° photographs and videos.

Further, the camera system of a client device 102 may include dual rear cameras (e.g., a primary camera as well as a depth-sensing camera), or even triple, quad or penta rear camera configurations on the front and rear sides of the client device 102. These multiple cameras systems may include a wide camera, an ultra-wide camera, a telephoto camera, a macro camera and a depth sensor, for example.

The position components 1336 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1302 further include communication components 1338 operable to couple the machine 1300 to a network 1322 or devices 1324 via respective coupling or connections. For example, the communication components 1338 may include a network interface Component or another suitable device to interface with the network 1322. In further examples, the communication components 1338 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1324 may be another machine or any of a wide variety of peripheral devices (e.g., a peripheral device coupled via a USB).

Moreover, the communication components 1338 may detect identifiers or include components operable to detect identifiers. For example, the communication components 1338 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1338, such as location via Internet Protocol (IP) geolocation, location via Wi-Fi® signal triangulation, location via detecting an NFC beacon signal that may indicate a particular location, and so forth.

The various memories (e.g., main memory 1314, static memory 1316, and memory of the processors 1304) and storage unit 1318 may store one or more sets of instructions and data structures (e.g., software) embodying or used by any one or more of the methodologies or functions described herein. These instructions (e.g., the instructions 1310), when executed by processors 1304, cause various operations to implement the disclosed examples.

The instructions 1310 may be transmitted or received over the network 1322, using a transmission medium, via a network interface device (e.g., a network interface component included in the communication components 1338) and using any one of several well-known transfer protocols (e.g., hypertext transfer protocol (HTTP)). Similarly, the instructions 1310 may be transmitted or received using a transmission medium via a coupling (e.g., a peer-to-peer coupling) to the devices 1324.

### Software Architecture

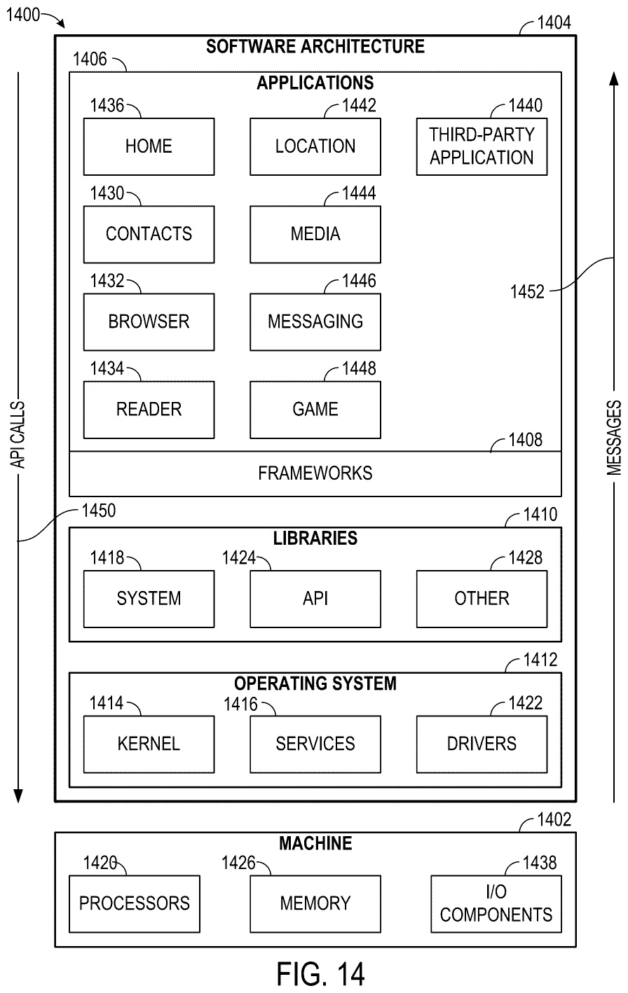

FIG. 14 is a block diagram 1400 illustrating a software architecture 1404, which can be installed on any one or more of the devices described herein. The software architecture 1404 is supported by hardware such as a machine 1402 that includes processors 1420, memory 1426, and I/O components 1438. In this example, the software architecture 1404 can be conceptualized as a stack of layers, where each layer provides a particular functionality. The software architecture 1404 includes layers such as an operating system 1412, libraries 1410, frameworks 1408, and applications 1406. Operationally, the applications 1406 invoke API calls 1450 through the software stack and receive messages 1452 in response to the API calls 1450.

The operating system 1412 manages hardware resources and provides common services. The operating system 1412 includes, for example, a kernel 1414, services 1416, and drivers 1422. The kernel 1414 acts as an abstraction layer between the hardware and the other software layers. For example, the kernel 1414 provides memory management, processor management (e.g., scheduling), component management, networking, and security settings, among other functionality. The services 1416 can provide other common services for the other software layers. The drivers 1422 are responsible for controlling or interfacing with the underlying hardware. For instance, the drivers 1422 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1410 provide a common low-level infrastructure used by the applications 1406. The libraries 1410 can include system libraries 1418 (e.g., C standard library) that provide functions such as memory allocation functions, string manipulation functions, mathematic functions, and the like. In addition, the libraries 1410 can include API libraries 1424 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1410 can also include a wide variety of other libraries 1428 to provide many other APIs to the applications 1406.

The frameworks 1408 provide a common high-level infrastructure that is used by the applications 1406. For example, the frameworks 1408 provide various graphical user interface (GUI) functions, high-level resource management, and high-level location services. The frameworks 1408 can provide a broad spectrum of other APIs that can be used by the applications 1406, some of which may be specific to a particular operating system or platform.

In an example, the applications 1406 may include a home application 1436, a contacts application 1430, a browser application 1432, a reader application 1434, a location application 1442, a media application 1444, a messaging application 1446, a game application 1448, and a broad assortment of other applications such as a third-party application 1440. The applications 1406 are programs that execute functions defined in the programs. Various programming languages can be employed to create one or more of the applications 1406, structured in a variety of manners, such as object-oriented programming languages (e.g., Objective-C, Java, or C++) or procedural programming languages (e.g., C or assembly language). In a specific example, the third-party application 1440 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1440 can invoke the API calls 1450 provided by the operating system 1412 to facilitate functionality described herein.

### Processing Components

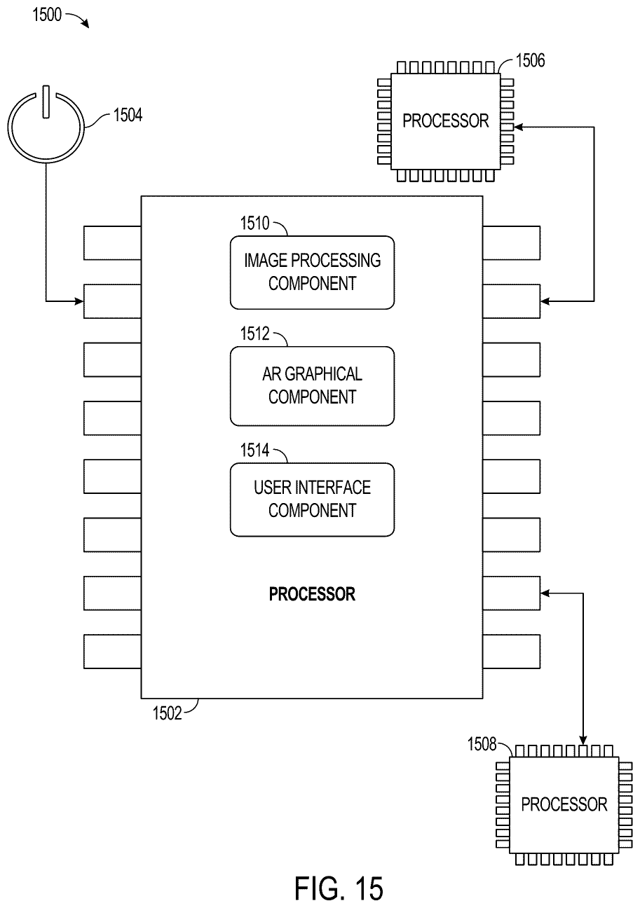

Turning now to FIG. 15, there is shown a diagrammatic representation of a processing environment 1500, which includes a processor 1502, a processor 1506, and a processor 1508 (e.g., a GPU, CPU or combination thereof).

The processor 1502 is shown to be coupled to a power source 1504, and to include (either permanently configured or temporarily instantiated) modules, namely an image processing component 1510, an AR graphical component 1512, and a user interface component 1514. The image processing component 1510 is invoked to process images 622 to determine screen 644 and other information regarding the screen 644 such as locations 646 and size 648 of the shared screen 642. For example, the ML module 649 processes the images 622 to generate the locations 646 and size 648 of the shared screen 642.

The AR graphical component 1512 displays avatars 638, augmentations 650, and the shared screen 642. For example, the AR graphics module 620, referring to FIG. 7, displays augmentation A 718, avatar A 714, and so forth. The screen 706 in FIG. 7 is not displayed by the “Host” AR wearable device 602 but would be displayed by a “Guest” AR wearable device 692. The AR graphics module 620 adjusts the avatars 638 and augmentations 650 in relationship to the shared screen 642, in accordance with the user view 609.

The user interface component 1514 interacts with the user 698 to determine the user intent 664 of the user 698. For example, the UI module 658 processes the haptic 601, gesture 603, voice 605, and position 607 input of user 698 to determine the user intent 664. The UI module 658 presents, on the display 608, a UI 662 including items 660 such as app carousel 732. As illustrated, the processor 1502 is communicatively coupled to both the processor 1506 and the processor 1508.

### Glossary

Certain examples are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example examples, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, an AR glasses, a VR glasses, an AR wearable device, a desktop computer, a laptop, a portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. An apparatus of a first extended reality (XR) wearable device, the apparatus comprising:
at least one processor; and
at least one memory storing instructions that, when executed by the at least one processor, configure the XR wearable device to perform operations comprising:
receiving an indication of a copy of a screen from a second XR wearable device;
determining a location of the copy of the screen within a physical location;
sending to the second XR wearable device an indication of a location and an indication of an orientation of the first XR wearable device relative to the determined location of the copy of the screen;
receiving, from the second XR wearable device, an indication of a location and an indication of an orientation of the second XR wearable device relative to a location of the screen;
determining a location of an avatar to have a same relative position to the copy of the screen as the second XR wearable device has to the screen; and
causing to be displayed on a display of the first XR wearable device the avatar to appear at the determined location of the avatar and to have a same relative orientation to the copy of the screen as the orientation of the second XR wearable device has relative to the screen.

2. The apparatus of claim 1, wherein the operations further comprise:
generating the avatar for the second XR wearable device to have a shape based on the location of the copy of the screen, the determined location of the avatar relative to the location of the copy of the screen, a relative orientation of the second XR wearable device to the screen, and a user view of a user of the first XR wearable device.

3. The apparatus of claim 2, wherein the orientation comprises a yaw value and a pitch value.

4. The apparatus of claim 3, wherein the orientation further comprises a roll value.

5. The apparatus of claim 1, wherein the operations further comprise:
displaying an augmentation at a location on the display of the second XR wearable device, the augmentation indicating that a user of the second XR wearable device is looking at the screen.

6. The apparatus of claim 1, wherein the operations further comprise:
displaying on the display of the first XR wearable device an indication of a name of a user of the second XR wearable device.

7. The apparatus of claim 1, wherein the operations further comprise:
receiving, from the second XR wearable device, a representation of the avatar.

8. The apparatus of claim 1, wherein the operations further comprise:
receiving streaming images of the screen from the second XR wearable device, wherein the images are one or more of: images of a user view of a real-world view of the first XR wearable device, images of the display of the first XR wearable device, images of an XR screen, or images of a computing device screen.

9. The apparatus of claim 1, wherein the second XR wearable device is in a remote location from the first XR wearable device.

10. The apparatus of claim 9, wherein the operations further comprise:
receiving streaming data from a microphone of the first XR wearable device; and
receiving data from a microphone of the second XR wearable device.

11. The apparatus of claim 1, wherein the operations further comprise:
accessing an augmentation added to the screen by a user of the first XR wearable device;
integrating the augmentation with an image of the copy of the screen; and
sending the image to the second XR wearable device.

12. The apparatus of claim 11, wherein the operations further comprise:
in response to a third XR wearable device being local to the first XR wearable device, and the copy of the screen being a physical screen or a computing device screen, sending to the third XR wearable device the augmentation.

13. The apparatus of claim 1, wherein the operations further comprising:
receiving, from the second XR wearable device, an indication of an augmentation and a location of the augmentation on the screen; and
displaying on the display of the first XR wearable device the augmentation at the location of the augmentation on the screen.

14. The apparatus of claim 1, wherein the operations further comprise:
displaying, on the display of the first XR wearable device, the screen at a first screen location, the first screen location being in a front location relative to a user of the first XR wearable device; and
in response to the user of the first XR wearable device moving their head or changing a location of their body, displaying, on the display of the first XR wearable device, the screen at a second screen location, the second screen location being in the front location relative to the user of the first XR wearable device.

15. The apparatus of claim 1, wherein sending further comprising:
sending the indication of the location of the first XR wearable device relative to the location of the copy of the screen via a paired user device using a low energy communications protocol.

16. The apparatus of claim 1, wherein the copy of the screen is displayed on a display of the first XR wearable device.

17. The apparatus of claim 1, wherein the avatar is a first avatar, and wherein the operations further comprise:
sending an indication of a second avatar to the second XR wearable device, the second avatar a representation of a user of the first XR wearable device.

18. A non-transitory computer-readable storage medium, the computer-readable storage medium including instructions that when executed by at least one processor of an apparatus of a first extended reality (XR) wearable device, cause the at least one processor to perform operations comprising:
receiving an indication of a copy of a screen from a second XR wearable device;
determining a location of the copy of the screen within a physical location;
sending to the second XR wearable device an indication of a location and an indication of an orientation of the first XR wearable device relative to the determined location of the copy of the screen;
receiving, from the second XR wearable device, an indication of a location and an indication of an orientation of the second XR wearable device relative to a location of the screen;
determining a location of an avatar to have a same relative position to the copy of the screen as the second XR wearable device has to the screen; and
causing to be displayed on a display of the first XR wearable device the avatar to appear at the determined location of the avatar and to have a same relative orientation to the copy of the screen as the orientation of the second XR wearable device has relative to the screen.

19. The non-transitory computer-readable storage medium of claim 18, wherein the operations further comprise:
generating the avatar for the second XR wearable device to have a shape based on the location of the copy of the screen, the determined location of the avatar relative to the location of the copy of the screen, a relative orientation of the second XR wearable device to the screen, and a user view of a user of the first XR wearable device.

20. A method performed on an apparatus of a first extended reality (XR) wearable device, the method comprising:
receiving an indication of a copy of a screen from a second XR wearable device;
determining a location of the copy of the screen within a physical location;
sending to the second XR wearable device an indication of a location and an indication of an orientation of the first XR wearable device relative to the determined location of the copy of the screen;
receiving, from the second XR wearable device, an indication of a location and an indication of an orientation of the second XR wearable device relative to a location of the screen;
determining a location of an avatar to have a same relative position to the copy of the screen as the second XR wearable device has to the screen; and
causing to be displayed on a display of the first XR wearable device the avatar to appear at the determined location of the avatar and to have a same relative orientation to the copy of the screen as the orientation of the second XR wearable device has relative to the screen.
